(19) United States
(12) Patent Application Publication
(10) Pub. No.: US 2015/0119129 A1
(43) Pub. Date: Apr. 30, 2015

(54) GAMING MACHINE WITH MULTI-INSTANCE TRIGGER FEATURE

(71) Applicant: Pridefield Limited, Douglas (GB)

(72) Inventor: Terence Igesund, Prestondale (ZA)

(21) Appl. No.: 14/521,219

(22) Filed: Oct. 22, 2014

(30) Foreign Application Priority Data
Oct. 23, 2013 (GB) 1318762.0

(51) Int. Cl. G07F 17/32

(52) U.S. Cl. CPC G07F 17/3213; G07F 17/326
USPC 463/20

(57) ABSTRACT

In one example, a machine includes: a display configured to display symbols in a game; a processor; and a non-transitory computer readable medium storing program instructions, that when executed by the processor, cause a set of functions to be performed, the set of functions including: selecting a first symbol set from a global symbol group, wherein the first symbol set includes at least two symbols; displaying on the display the selected first symbol set; making a determination that a second symbol set, which is a proper sub-set of the selected first symbol set, satisfies a trigger condition; responsive to making the determination, for each symbol in the second symbol set, selecting a corresponding replacement symbol from the global symbol group, such that a third symbol set consisting of the replacement symbols satisfies the trigger condition; and displaying on the display the third symbol set.

### PRIORITY

This application claims priority under 35 U.S.C. §119 to United Kingdom Patent Application No. 1318762.0 filed Oct. 23, 2013, which is hereby incorporated by reference in its entirety.

### TECHNICAL FIELD

This disclosure relates to gaming machines for playing games such as wager games.

### BACKGROUND

Wager games come in a variety of forms, including for example a mechanical slot machine. A mechanical slot machine may include one or more reels, each of which includes multiple symbols distributed around the circumference of the reel. When a player places a wager (e.g., by placing a coin in the machine), the player is allowed to spin the reels. Each reel then comes to rest, typically with either one of the symbols, or a space in between symbols, in alignment with a pay line. A predetermined winning symbol or a predetermined combination of winning symbols that are aligned with the pay line may result in the player winning the game and receiving a payout. In one example, the machine may include three reels, and the pay line may be a horizontal line disposed across a center of each of the three reels.

In another example of a wager game, a mechanical slot machine may present symbols in a matrix arrangement, with each symbol changing during a spin of the game. For example, the machine may have five columns and three rows of symbols, for a total of fifteen symbols. Such machines often have multiple pay lines, each being defined by a collection of positions within the matrix. For example, the machine may have three pay lines, each corresponding to one row of the matrix.

While slot machines were traditionally mechanical, modern slot machines often take the form of a video gaming machine (e.g., a dedicated gaming machine located in a casino) that includes a graphical user interface (GUI), and that may emulate a mechanical slot machine. With a video gaming machine, the GUI may include a display that displays an image of one or more reels or a matrix as described above, together with animation effects to simulate a spin of the game. A computer software program, which may reside in the video gaming machine, may randomly select one or more symbols in response to a spin, and may display the result on the display.

A modern slot machine may also be played over a computer network, such as by a player using a client machine that is connected to a server machine over the computer network. In this instance, the server machine may perform the spins of the game and may send the resulting symbols to the client machine for display.

### SUMMARY

Viewed from one aspect, the disclosure provides a gaming machine for playing a game in which symbols are selected and/or displayed by the machine, the gaming machine comprising means for selecting symbols and means for displaying symbols characterised in that the machine is configured to carry out the following steps: selecting a first symbol set from a global symbol group, wherein the first symbol set includes at least two symbols; displaying on a display the selected first symbol set; making a determination that a second symbol set, which is a proper sub set of the selected first symbol set, satisfies a trigger condition; responsive to making the determination, for each symbol in the second symbol set, selecting a corresponding replacement symbol from the global symbol group, such that a third symbol set consisting of the replacement symbols satisfies the trigger condition; and displaying on the display the third symbol set.

There may be a plurality of symbols in the second symbol set. Each symbol in the second symbol set may be replaced by the same replacement symbol. Alternatively, symbols in the second symbol set may be replaced by different respective replacement symbols.

In some embodiments, the or each replacement symbol is predetermined (i.e., determined at least before making the determination that the second symbol set satisfies the trigger condition).

In some embodiments, the or each replacement symbol is selected from the global symbol group after, such as in response to, determining that the second symbol set satisfies the trigger condition.

In some embodiments, the machine is further configured to carry out the following steps: receiving a play request, via a user interface; and responsive to receiving the play request, selecting the first symbol set from the global symbol group; and wherein the trigger condition comprises a condition of the first symbol set including a particular combination and/or arrangement of symbols as indicated in a payout table of the machine.

In some embodiments, the machine is further configured to carry out the following step: for each symbol included in the second symbol set, displaying an indication of the symbol. Displaying the indication of the symbol may comprise highlighting the symbol.

In some embodiments, the first symbol set includes multiple sub sets and the global symbol group includes multiple sub groups, wherein each sub group corresponds to a respective one of the sub sets, and wherein selecting the first symbol set from the global symbol group comprises selecting each sub set from the corresponding sub group.

In some embodiments, each symbol in the first symbol set may correspond with a respective arrangement position of an arrangement. In such embodiments, displaying the first symbol set may involve displaying each symbol in the first symbol set in the corresponding arrangement position. In one example, the arrangement is a matrix or column and row arrangement. Such an arrangement includes multiple arrangement positions, one for each column and row combination.

By way of example, a column and row arrangement may comprise five columns and four rows. Such an arrangement therefore comprises twenty arrangement positions.

In embodiments where the arrangement is a column and row arrangement and the first symbol set includes multiple sub sets, each sub set may correspond with a respective column of the arrangement. As such, displaying the first symbol set may involve displaying each sub set in a corresponding column of the arrangement. In some embodiments, displaying each sub set in the corresponding column may comprise superimposing each sub set over a corresponding reel. In some embodiments, the gaming machine includes data processing means and data storage, which for each symbol in the global symbol group, stores an identifier and a corresponding displayable image, and wherein displaying the first symbol set comprises displaying the displayable image corresponding with each symbol in the first symbol set.

In some embodiments, the game is a wager game and the machine is configured to carry out the following steps: receiving a wager via a user interface; determining, using a stored payout table, a first payout amount, wherein the first payout amount is a function of the received wager and the selected first symbol set; displaying the determined first payout amount; determining, using the stored payout table, a second payout amount, wherein the second payout amount is a function of the wager and the second symbol set and; displaying the determined second payout amount.

In some embodiments, the trigger condition comprises a condition of including a particular combination of symbols, and the machine is configured to carry out the step of displaying the symbols in the third symbol set superimposed over the symbols in the second symbol set.

In some embodiments, each symbol in the global symbol group corresponds with a respective number or numbers from a set of numbers, and wherein selecting the first symbol set from the global symbol group comprises using a random number generator to select numbers from the set of numbers to select symbols corresponding with the selected numbers. Multiple numbers may correspond to one or more symbols to provide weighting to those one or more symbols.

The gaming machine may be in the form of a standalone gaming machine which incorporates a data processing module and a display. Alternatively, the gaming machine may comprise a gaming server and client which incorporates a data processing module and a display, the server and the client being remote from each other.

Viewed from a second aspect, the disclosure provides a method for playing a game in which symbols are selected and/or displayed; characterised by selecting a first symbol set from a global symbol group, wherein the first symbol set includes at least two symbols; displaying on a display the selected first symbol set; making a determination that a second symbol set, which is a proper sub set of the selected first symbol set, satisfies a trigger condition; responsive to making the determination, for each symbol in the second symbol set, selecting a corresponding replacement symbol from the global symbol group, such that a third symbol set consisting of the replacement symbols satisfies the trigger condition; and displaying on the display the third symbol set.

Viewed from a third aspect, the disclosure provides a server machine for use in playing a game in which symbols are selected and/or displayed, the server machine being configured to communicate with a client machine over a computer network, and the server machine comprising a processor and a computer readable medium storing software instructions, that when executed by the processor, perform functions on the server machine comprising selecting a first symbol set from a global symbol group, wherein the first symbol set includes at least two symbols and sending the first symbol set to the client machine for displaying on a display; characterised in that the functions include: making a determination that a second symbol set, which is a proper sub set of the selected first symbol set, satisfies a trigger condition; responsive to making the determination, for each symbol in the second symbol set, selecting a corresponding replacement symbol from the global symbol group, such that a third symbol set consisting of the replacement symbols satisfies the trigger condition; and sending the selected replacement symbols to the client machine for displaying on the display.

Viewed from a fourth aspect, the disclosure provides a client machine for playing a game in which symbols are displayed, the client machine being in communication with a server machine and comprising: a display configured to display symbols; a processor; and a computer readable medium storing software instructions, that when executed by the processor, perform functions on the data processing system, the functions comprising: receiving from the server machine a first symbol set selected from a global symbol group, wherein the first symbol set includes at least two symbols; and displaying on the display the selected first symbol set; characterised by receiving from a server machine a first symbol set, wherein the first symbol set includes at least two symbols from a global symbol group, and wherein a second symbol set, which is a proper sub-set of the received first symbol set, satisfies a trigger condition; displaying on the display the received first symbol set; receiving from the server machine, for each symbol in the second symbol set, a corresponding replacement symbol from the global symbol group, such that a third symbol set consisting of the replacement symbols satisfies the trigger condition; and displaying the third symbol set.

Viewed from a fifth aspect, the disclosure provides a computer software product for configuring a data processing system for playing a game in which symbols are selected and/or, the software product comprising instructions, that when executed by a processor of the data processing system will cause the data processing system to carry out the following functions: selecting a first symbol set from a global symbol group, wherein the first symbol set includes at least two symbols; displaying on a display the selected first symbol set; making a determination that a second symbol set, which is a proper sub set of the selected first symbol set, satisfies a trigger condition; responsive to making the determination, for each symbol in the second symbol set, selecting a corresponding replacement symbol from the global symbol group, such that a third symbol set consisting of the replacement symbols satisfies the trigger condition; and displaying on the display the third symbol set.

The features listed above as being features of embodiments of the first aspect of the disclosure, are equally applicable to embodiments of the second, third, fourth and fifth embodiments of the disclosure.

In embodiments of the disclosure in which a computer software product is used, the product may be non-transitory and store instructions on physical media such as a DVD, or a solid state drive, or a hard drive. Alternatively, the product may be transitory and in the form of instructions provided over a connection such as a network connection which is linked to a network such as the Internet.

Disclosed herein are machines and methods for playing games such as wager games. In one aspect, a machine is disclosed that includes a display configured to display symbols in a game, a processor, and a non-transitory computer readable medium storing software program instructions, that when executed by the processor, cause a set of functions to be performed. The set of functions includes (i) selecting a first symbol set from a global symbol group, wherein the first symbol set includes at least two symbols, (ii) displaying on the display the selected first symbol set, (iii) making a determination that a second symbol set, which is a proper sub set of the selected first symbol set, satisfies a trigger condition; (iv) responsive to making the determination, for each symbol in the second symbol set, selecting a corresponding replacement symbol from the global symbol group, such that a third symbol set consisting of the replacement symbols satisfies the trigger condition; and (v) displaying on the display the third symbol set.

In another aspect, a server machine is disclosed. The server machine is configured to communicate with a client machine over a computer network, the client machine including a display configured to display symbols in a game. The server machine includes a processor and a non-transitory computer readable medium storing software instructions, that when executed by the processor, perform a set of functions. The set of functions includes: (i) selecting a first symbol set from a global symbol group, wherein the first symbol set includes at least two symbols; (ii) sending the selected first symbol set to the client machine for display on a display; (iii) making a determination that a second symbol set, which is a proper sub set of the selected first symbol set, satisfies a trigger condition; (iv) responsive to making the determination, for each symbol in the second symbol set, selecting a corresponding replacement symbol from the global symbol group, such that a third symbol set consisting of the replacement symbols satisfies the trigger condition; and (v) sending the selected replacement symbols to the client machine for displaying on the display.

In another aspect, a client machine is disclosed. The client machine is configured to communicate with a server machine over a computer network. The client machine includes a display configured to display symbols of a game, a processor, and a non-transitory computer readable medium storing software instructions, that when executed by the processor, perform a set of functions. The set of functions includes: (i) receiving from the server machine a first symbol set, wherein the first symbol set includes at least two symbols from a global symbol group, and wherein a second symbol set, which is a proper sub-set of the received first symbol set, satisfies a trigger condition; displaying on the display the received first symbol set; receiving from the server machine, for each symbol in the second symbol set, a corresponding replacement symbol from the global symbol group, such that a third symbol set consisting of the replacement symbols satisfies the trigger condition; and displaying the third symbol set

In another aspect, a method for use with a display configured to display symbols in a game is disclosed. The method involves: (i) selecting, using a processor, a first symbol set from a global symbol group, wherein the first symbol set includes at least two symbols, (ii) displaying on the display the selected first symbol set; (iii) making a determination that a second symbol set, which is a proper sub set of the selected first symbol set, satisfies a trigger condition; (iv) responsive to making the determination, for each symbol in the second symbol set, selecting a corresponding replacement symbol from the global symbol group, such that a third symbol set consisting of the replacement symbols satisfies the trigger condition; and (v) displaying on the display the third symbol set.

### BRIEF DESCRIPTION OF THE DRAWINGS

Some embodiments of the disclosure will now be described by way of example and with reference to the accompanying drawings, in which:

FIG. 1 is a simplified block diagram of an embodiment of a machine in accordance with the disclosure;

FIG. 2 is a simplified block diagram of an example server machine connected to an example client machine over a computer network, in an embodiment of the disclosure;

FIG. 3A is a first part of a flow chart showing functions in accordance with a method in an embodiment of the disclosure;

FIG. 3B is a second part of the flow chart of FIG. 3A;

FIG. 3C is a third part of the flow chart of FIG. 3A;

FIG. 4 includes diagrams of tables used in accordance with machines and methods in embodiments of the disclosure;

FIG. 5 depicts a first state of a display in accordance with an embodiment of a machine and method in accordance with the disclosure;

FIG. 6 depicts a second state of a display in accordance with an embodiment machine and method in accordance with the disclosure;

FIG. 7 depicts a third state of a display in accordance with an embodiment of a machine and method in accordance with the disclosure;

FIG. 8A is a first part of a flow chart showing functions in accordance with another method in an embodiment of the disclosure, in connection with an example server machine;

FIG. 8B is a second part of the flow chart of FIG. 8A;

FIG. 8C is a third part of the flow chart of FIG. 8A;

FIG. 9A is a first part of a flow chart showing functions in accordance with another method in an embodiment of the disclosure, in connection with an example client machine;

FIG. 9B is a second part of the flow chart of FIG. 9A; and

FIG. 9C is a third part of the flow chart of FIG. 9A.

### DETAILED DESCRIPTION

Throughout this disclosure, any reference to “a” or “an” refers to “at least one,” and any reference to “the” refers to “the at least one,” unless otherwise specified, or unless the context clearly dictates otherwise.

Disclosed herein are machines and methods for playing games such as wager games. In one aspect, the machines and methods provide a supplementary win feature that may enhance traditional wager games (e.g., slot machines or other reel-type games) by providing a player with additional opportunities to win the game, thereby increasing the player's interest, anticipation, and excitement in connection with the game. This may in turn benefit a casino or another entity that provides a game with this feature. Indeed, wager games are typically configured to have odds that favor the casino (sometimes referred to as the “house”). Accordingly, based on the law of averages, casinos often maximize their profits simply by getting more players to play more games. Due to the supplementary win feature, players may be drawn in (e.g., from competing casinos that lack games with such a feature) and they may play the game often.

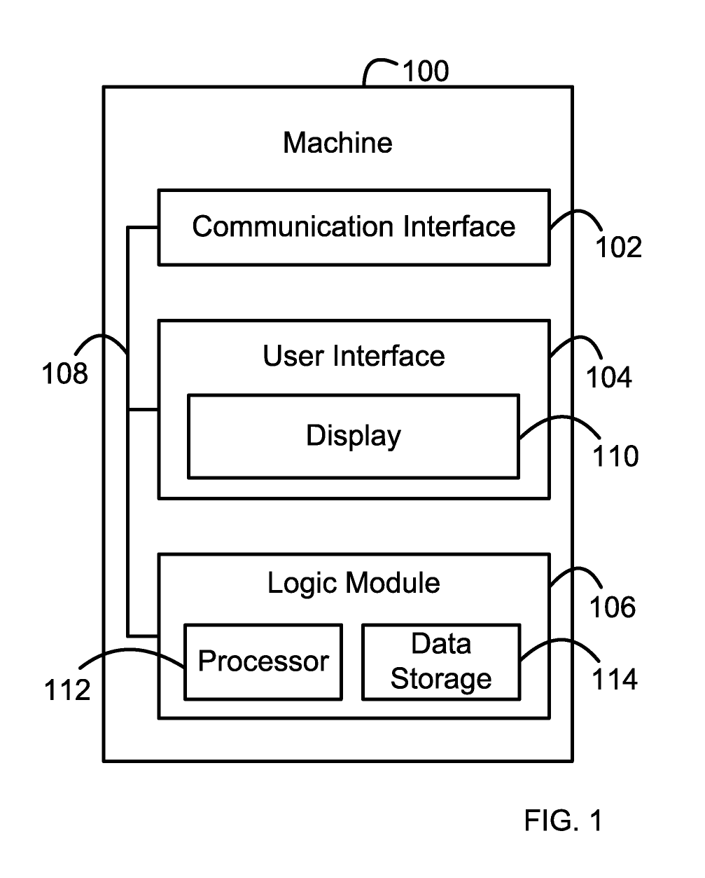

FIG. 1 shows a simplified block diagram of an example machine 100 arranged to implement functions in accordance with example methods described herein. The machine 100 may take any of a variety of forms, including for example a dedicated gaming machine, personal computer, personal digital assistant, mobile phone, tablet device, or other computing device.

The machine 100 may include a communication interface 102, a user interface 104, and a logic module 106, all of which may be coupled together by a system bus, network, or other connection mechanism 108. The communication interface 102 may include a wired or wireless network communication interface.

The user interface 104 may facilitate interaction with a user (e.g., a player of a game) if applicable. As such, the user interface 104 may take the form of a GUI and may include output components such as a speaker and a display 110, and input components such as a keypad or a touch sensitive screen. As described in greater detail below, the display 110 may be configured to display, among other things, a symbol set in a game.

The logic module 106 may take the form of a processor 112 and a data storage 114. The processor 114 may include a general purpose processor (e.g., a microprocessor) and/or a special purpose processor (e.g., a digital signal processor and/or application specific integrated circuit) and may be integrated in whole or in part with the communication interface 102 and/or the user interface 104.

The data storage 114 may include volatile and/or non-volatile storage components and may be integrated in whole or in part with the processor 112. The data storage 114 may take the form of a non-transitory computer readable medium and may include software program instructions, that when executed by the processor 114, cause the machine 100 to perform one or more of the functions described herein.

The data storage 114 may also include operating system software on which the machine 100 may operate. For example, the machine 100 may operate on a Windows™ based operating system (e.g., Windows XP or Windows 7) provided by the Microsoft™ Corporation of Redmond, Wash.

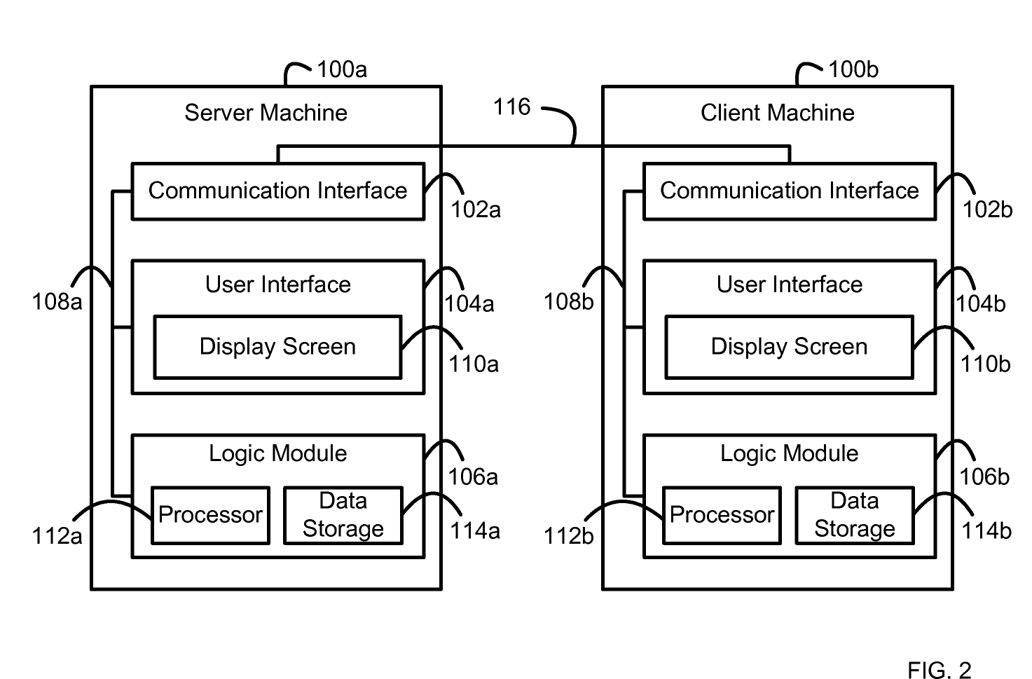

FIG. 2 is a simplified block diagram of an example server machine 100a connected to an example client machine (sometimes referred to as a workstation) 100b over a computer network 116. The components of the server machine 100a and the client machine 100b are shown with corresponding “a” and “b” reference numerals (i.e., based on the machine 100). The server machine 100a is configured to communicate with the client machine 100b over the computer network 116 (via the communication interfaces 102a, 102b). Likewise, the client machine 100b is configured to communicate with the server machine 100a over the computer network 116. In such server client based configurations, the server machine 100a and/or the client machine 100b may perform one or more of the functions described herein.

The computer network based server client configuration described above may take a variety of forms. For example, the computer network 116 may be a local area network (LAN) in a casino, such that client machines 100b dispersed throughout the casino may communicate with the server machine 100a in the casino.

In another example, the computer network 116 may be a wide area network (WAN), such as an Internet network. In such a configuration, the client machines 100b may communicate with the server machine 100a via a website portal (for a virtual casino) hosted on the server machine 100a.

The computer network 116 may include any of a variety of network topologies and network devices, and may employ traditional network related technologies, including for example the public switched telephone network, cable networks, cellular wireless networks, WiFi, and WiMax. Further, the computer network may include one or more databases (e.g., a player credit account database), to allow for the storing and retrieving of data related to the game.

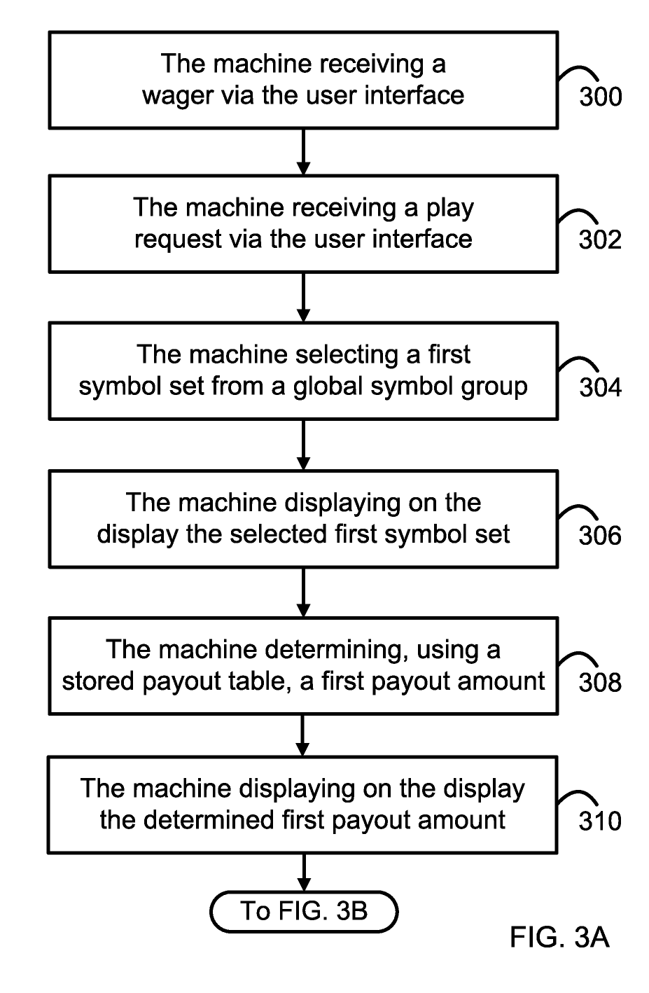

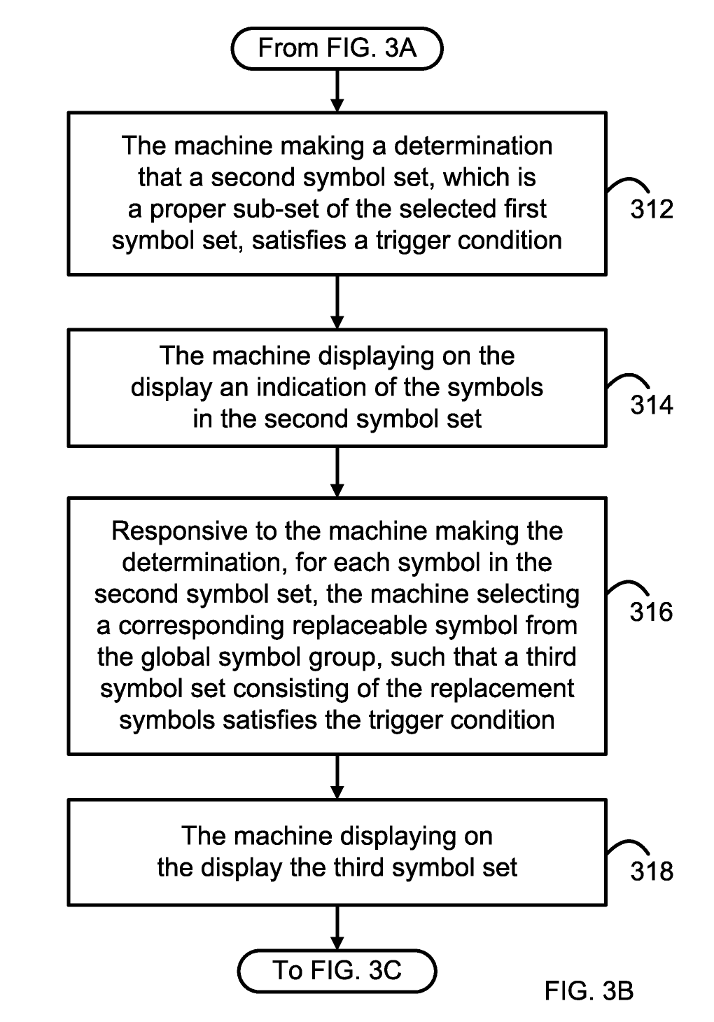

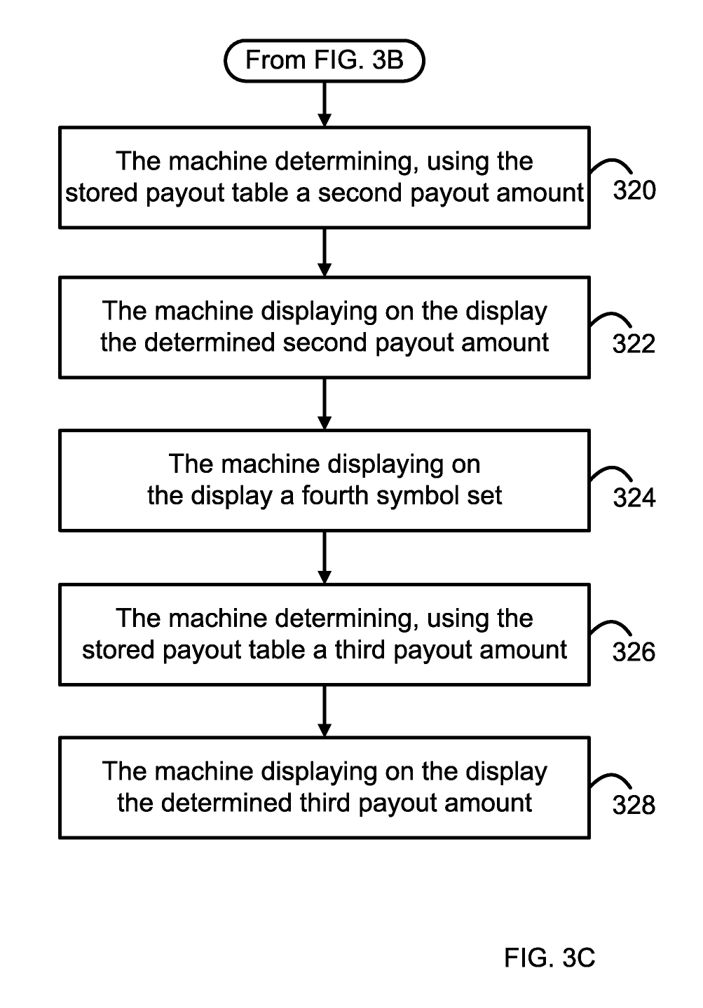

FIGS. 3A-3C show a flow chart showing functions in accordance with an example method in connection with the machine 100. The example method relates to a wager game.

At block 300, the method may involve the machine 100 receiving a wager via the user interface 104. In one example, this may allow a player to enter a wager of the wager game on a keypad on the machine 100. In one example, a player may have a corresponding player credit balance from which the wager may be deducted in response to the machine 100 receiving a play request from the player. For example, a player may have a player credit balance of 100,000, which may be reduced to 99,750 credits upon the player requesting a play of the game with a wager of 250 credits. In one example, the method may further involve the machine 100 displaying on the display 110 the player credit balance and/or the wager amount.

At block 302, the method may involve the machine 100 receiving a play request (e.g., a “spin” request) via the user interface 104. In one example, this may allow a player to pull a level or push a button on the machine 100 to request a play of the wager game. As noted above, this may result in the player's credit balance being reduced by the player's wager.

At block 304, the method may involve the machine 100 selecting a first symbol set from a global symbol group. In one example, the machine 100 selects the first symbol set from the global symbol group responsive to the machine 100 receiving the play request.

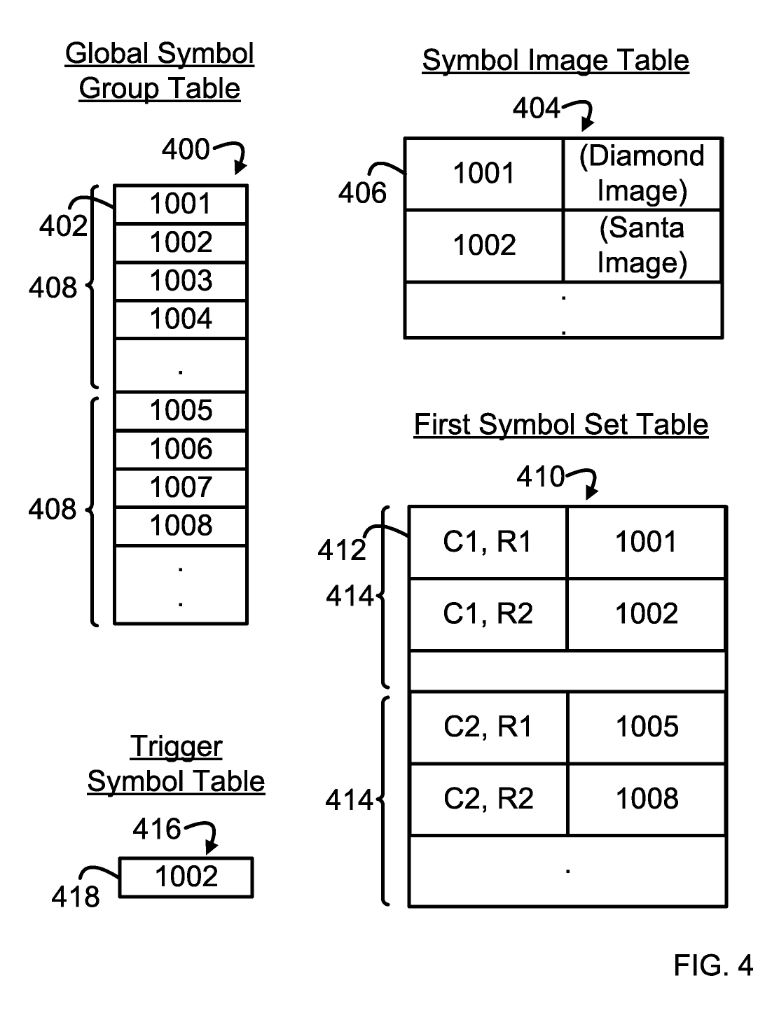

The global symbol group includes multiple symbols, such as a Club, a Diamond, a Heart, a Spade, a Santa, or a Roast Turkey, that may be used in connection with the wager game. The global symbol group may be customized with particular symbols as desired. In one example, the global symbol group may be represented as a table (or other data structure) stored in the data storage 114. FIG. 4 shows an example global symbol group table 400. The global symbol group table 400 includes multiple records 402, each including an identifier that represents a particular symbol. In one example, the global symbol group, and therefore the global symbol table 400, may be divided into multiple sub groups 408 as discussed in greater detail below.

The global symbol group table 400 may be used in connection with a symbol image table 404. The symbol image table 404 includes multiple records 406, each including an identifier that represents a particular symbol, and a corresponding displayable image. As such, the symbol image table 404 may be used to map an identifier in the global symbol group table 400 to a displayable image.

The selected first symbol set may be represented by a table 410. The table 410 includes multiple records 412, each including an arrangement position of the symbol, and an identifier that represents the symbol. As such, each symbol in the selected first symbol set may correspond with a respective arrangement position in an arrangement (e.g., both a column number and row number in a column-and-row arrangement).

In one example, the machine 100 may select the first symbol set by iterating though each record 412 in the first symbol set table 410, and select a symbol identifier from among the symbol identifiers in the global symbol group table 400. In one example, the symbol identifiers are numbers and the machine 100 uses a random number generator to select such numbers, and therefore to randomly select symbols.

In one example, the machine 100 may select each sub-set in the symbol set from the corresponding sub group in the global symbol group. This type of selection may be used when the symbol set represents one or more reels in a reel type wager game. In this instance, each sub-group includes all the symbols of a given reel, and the selected sub-set includes the symbols of the reel that are “in play,” namely those included in the selected first symbol set.

Returning to FIG. 3A, at block 306, the method may involve the machine 100 displaying on the display 110 the selected first symbol set. In one example, the machine 100 may display a first symbol set on the display 110 by displaying the displayable image associated with each symbol in the selected first symbol set (e.g., according to the symbol image table 404).

In one example, the machine 100 may display the selected first symbol set in a column and row arrangement by displaying each symbol in the selected first symbol set according to the corresponding arrangement position. Further, where the column and row arrangement is used to simulate reels, the machine 100 may display each sub set in a corresponding column of the arrangement, such as by superimposing each sub set over a virtual reel in the corresponding column.

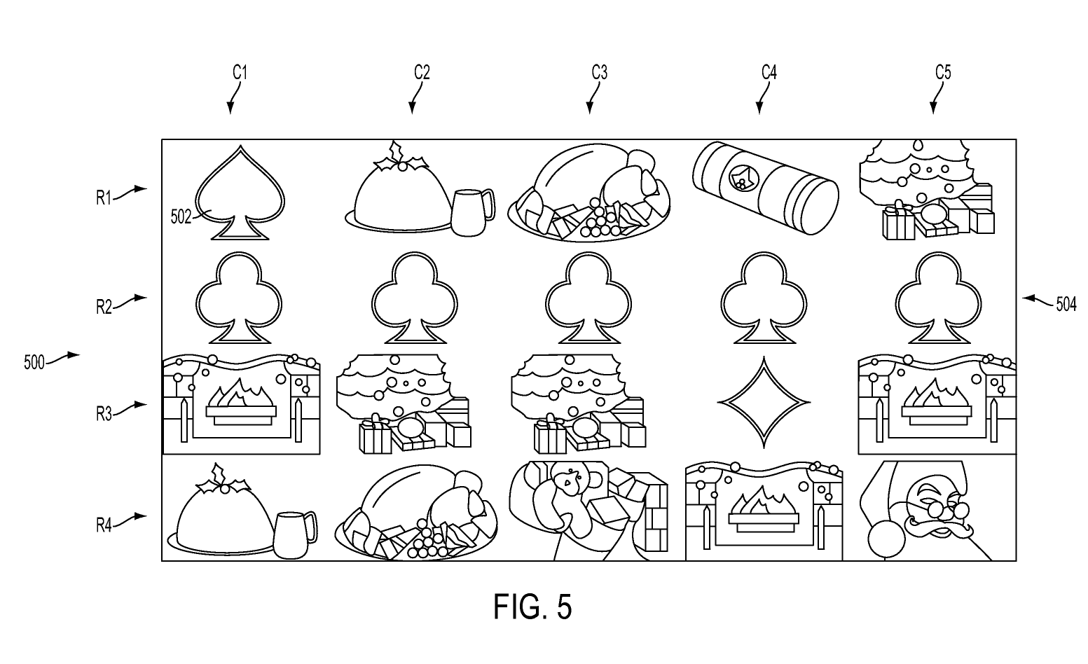

FIG. 5 shows an example of a first symbol set 500 displayed on the display 110. The displayed first symbol set 500 includes twenty symbols 502 arranged in five columns C1-C5 and four rows R1-R4, with each symbol of the first symbol set 500 being displayed in a corresponding position of the arrangement.

Returning to FIG. 3A, at block 308, the method may involve the machine 100 determining, using a stored payout table, a first payout amount, where the first payout amount may be a function of the received wager, the selected first symbol set, and/or the arrangement of symbols in the first symbol set. In one example, the stored payout table may map a given symbol set and/or a particular arrangement to a payout multiplier. As such, the received wager may be multiplied by the appropriate payout multiplier to determine the first payout amount.

At block 310, the method may involve the machine 100 displaying on the display 110 the determined first payout amount. In one example, the machine 100 may also physically dispense a corresponding payout (e.g., cash), or otherwise facilitate the payout to the player (by adding funds to an electronic account associated with a gaming card).

For example, wherein the machine 100 has determined, using the stored payout table, a first payout amount of 300 credits, the machine 100 may display on the display 110 the determined first payout amount of 300 credits. Additionally or alternatively, the machine 100 may add the determined first payout amount to the player credit balance and then display the updated player credit balance. For instance, where the player credit balance was 99,750 before the first payout amount was determined, the machine 100 may add the determined first payout amount of 300 credits to the player credit balance so that the updated player credit balance is 10,050 credits. The machine 100 may then display on the display 110 the updated balance of 10,050 credits.

Turning to FIG. 3B, at block 312, the method may involve the machine 100 making a determination that a second symbol set, which is a proper sub set of the selected first symbol set, satisfies a trigger condition. Since the second symbol set is a proper sub-set of the first symbol set, the second sub-set consists of at least a portion, but not all of the symbols included in the first symbol set.

The trigger condition may be one of a variety of different conditions. For example, the trigger condition may be a condition of including a particular combination of symbols. For instance, the second symbol set may satisfy the trigger condition if it includes three of the same symbol (e.g., three Hearts or three Clubs). As another example, the second symbol set may satisfy the trigger condition if it includes two specific symbols (e.g., one Heart and one Club). In some examples, the particular combination may be a winning combination as indicated in the stored payout table.

As another example, the trigger condition may be a condition of including a particular combination of symbols that correspond with particular arrangement positions. For instance, the second symbol set may satisfy the trigger condition if it includes five of the same symbols that correspond with five arrangement positions that collectively constitute any single row (or one or more particular rows such as a bottom row or top row) in a column and row arrangement. In one example, the particular combination and particular arrangement positions may be a winning combination as indicated in the stored payout table. Note that while a few example trigger conditions have been described above, any of a variety of other trigger conditions could be used to suit a desired configuration.

FIG. 5 shows a second symbol set 504, which is a proper sub set of the selected first symbol set 500, and that satisfies a trigger condition of including five of the same symbols that correspond with five arrangement positions that collectively constitute a single row. In particular, the second symbol set 504 includes five Clubs positioned in row R2 (at positions C1,R2; C2,R2; C3,R2; C4,R2; and C5,R2 respectively).

At block 314, the method may involve the machine 100 displaying on the display 110 an indication of the symbols in the second symbol set. In one example, the machine 100 may display such an indication by highlighting, shading, hatching or adding a border around the symbols, but other indication techniques may be used.

At block 316, the method may involve responsive to the machine 100 making the determination, for each symbol in the second symbol set, the machine 100 selecting a corresponding replacement symbol from the global symbol group, such that a third symbol set consisting of the replacement symbols satisfies the trigger condition (i.e., the same trigger condition satisfied by the second symbol set).

In one example, the machine 100 may use a random number generator to select the replacement symbols as with the selection of the first symbol set described above. Further, the act of selecting a corresponding replacement symbol for each symbol in the second symbol set may involve selecting a single replacement symbol to replace all of the symbols in the second symbol set. Alternatively, the act of selecting a corresponding replacement symbol for each symbol in the second symbol set may involve making an individual selection of a corresponding replacement symbol for each symbol of the second symbol set. These individual selections could be selections of the same symbol or selections of different symbols.

At block 318, the method may involve the machine 100 displaying on the display 110 the third symbol set.

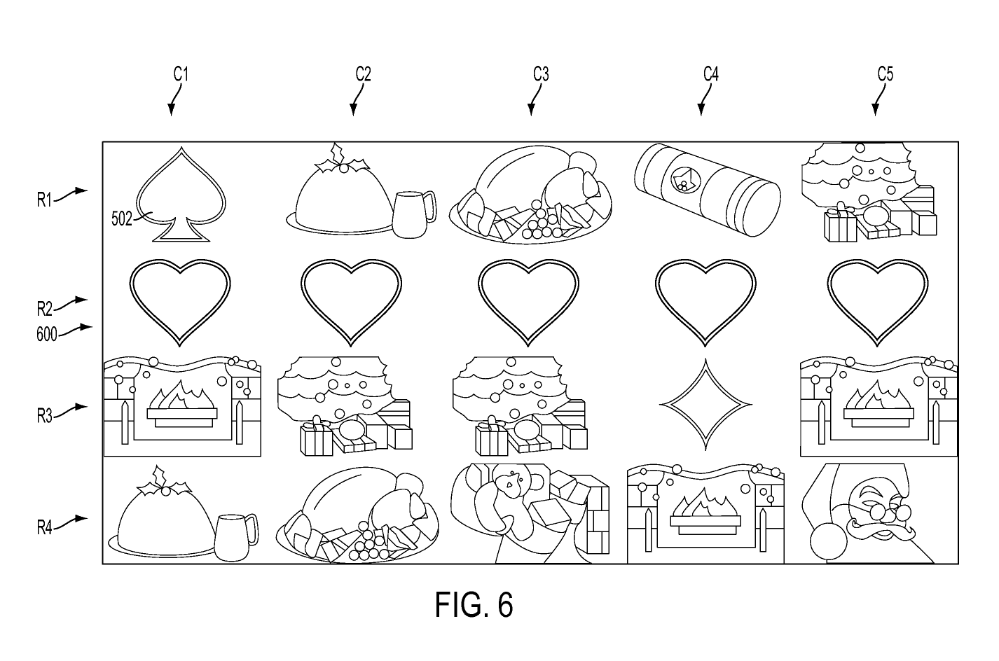

FIG. 6 shows a displayed third symbol set 600 consisting of five Hearts positioned in row R2 (at positions C1,R2; C2,R2; C3,R2; C4,R2; and C5,R2 respectively). As such, this third symbol set 600 satisfies the trigger condition of including five of the same symbols that correspond with five arrangement positions that collectively constitute a single row.

In one example, the machine 100 may display the selected replacement symbols superimposed over the symbols in the second symbol set. Additionally, or alternatively, as shown in FIG. 6, the remaining symbols in the first symbol set (i.e., those not in the second symbol set), may be darkened or otherwise modified while the replacement symbols are selected so as to draw a user's attention to the third symbol set 600.

Turning to FIG. 3C, at block 320, the method may involve the machine 100 determining, using the stored payout table a second payout amount. Similar to the first payout amount, the second payout amount may be a function of the received wager, the second symbol set, and/or the arrangement of symbols in the second symbol set. As with the first payout amount, the machine 100 may also physically dispense a corresponding payout (e.g., the determined second payout amount or a combination of the determined first and second payout amounts) or otherwise facilitate the payout to the player.

At block 322, the method may involve the machine 100 displaying on the display 110 the determined second payout amount. For example, where the machine 100 has determined, using the stored payout table, a second payout amount of 675 credits, the machine may display on the display 110 the determined second payout amount of 675 credits. Additionally or alternatively, the machine may add the determined second payout amount to the player credit balance and display the updated player credit balance. For instance, where the player credit balance was 100,050 credits before the second payout amount was determined, the machine 100 may add the determined second payout amount of 675 credits to the player credit balance so that the updated balance is 100,725 credits.

In one example, the trigger condition may be satisfied multiple times by means of iterative symbol replacement, and may result in a sequence of more than two instances of the trigger condition being satisfied. As such, some or all of the functions described above may be repeated.

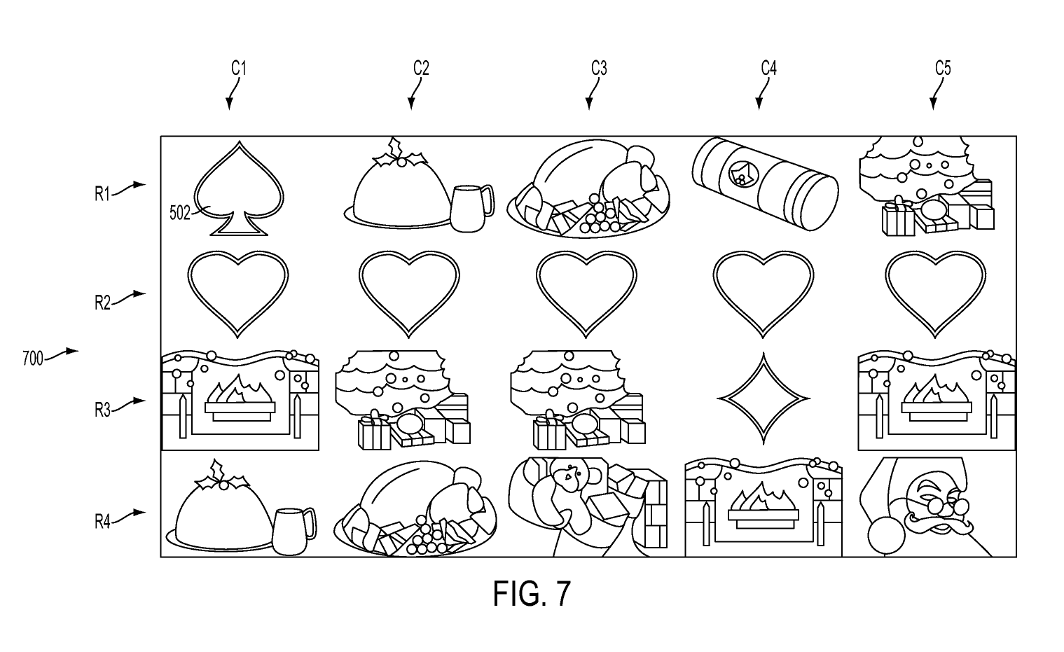

At block 324, the method may involve the machine 100 displaying on the display 110, a fourth symbol set. The displayed fourth symbol set is identical to the displayed first symbol set, except that the second symbol set portion of the first symbol set is replaced by the third symbol set. For example, as shown in the FIG. 7, a displayed fourth symbol set 700 is identical to the displayed first symbol set 500 (FIG. 5), except that the second symbol set 504 portion (FIG. 5) is replaced by the third symbol set 600 (FIG. 6). Accordingly, the fourth symbol set 700 includes the five selected replacement symbols that make up the third symbol set 600 (at the positions C1,R2; C2,R2; C3,R2; C4,R2; and C5, R2, respectively).

At block 326, the method may involve the machine 100 determining, using the stored payout table a third payout amount. Similar to the first and second payout amounts, the third payout amount may be a function the received wager, the displayed fourth symbol set, and/or the arrangement of symbols in the third symbol set. As with the first and second payout amounts, the machine 100 may also physically dispense a corresponding payout (e.g., the determined second payout amount or a combination of the determined first, second, and third payout amounts) or otherwise facilitate the payout to the player.

At block 328, the method may involve the machine 100 displaying on the display 110 the determined third payout amount. For example, where the machine 100 has determined, using the stored payout table a third payout amount of 225 credits, the machine may display on the display 110 the determined third payout amount of 225 credits. Additionally or alternatively, the machine may add the determined third payout amount to the player credit balance and display the updated player credit balance. For instance, where the player credit balance was 100,725 credits before the fourth payout amount was determined, the machine 100 may add the determined third payout amount of 225 credits to the player credit balance so that the updated balance is 101,000 credits.

Additionally or alternatively to determining the third payout amount (or the first or second payout amount), the machine 100 may perform other actions to award the player. For instance, the machine may display an indication of a tangible prize. Other types of awards may be used as well.

In some instances, the method may further involve the machine 100 making a determination that the third symbol set 504 satisfies the trigger condition, and responsive to the machine making the determination that the third symbol set satisfies the trigger condition, displaying on the display 110 an indication that the trigger condition has twice been satisfied. This indication may take a variety of forms. For example, the indication may include text that states “Five of a Kind, Again.”

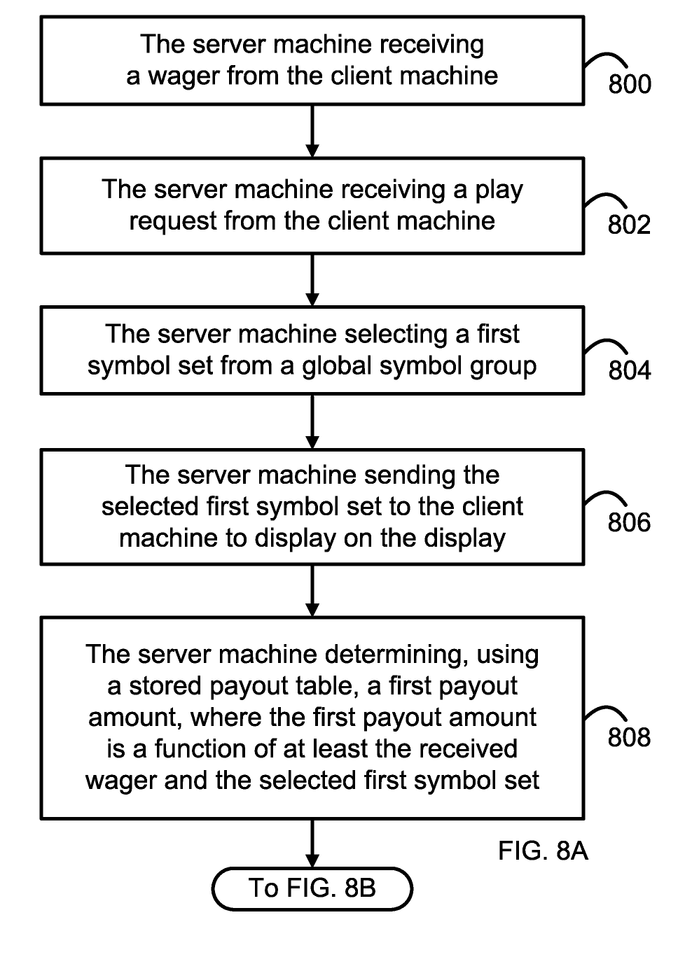

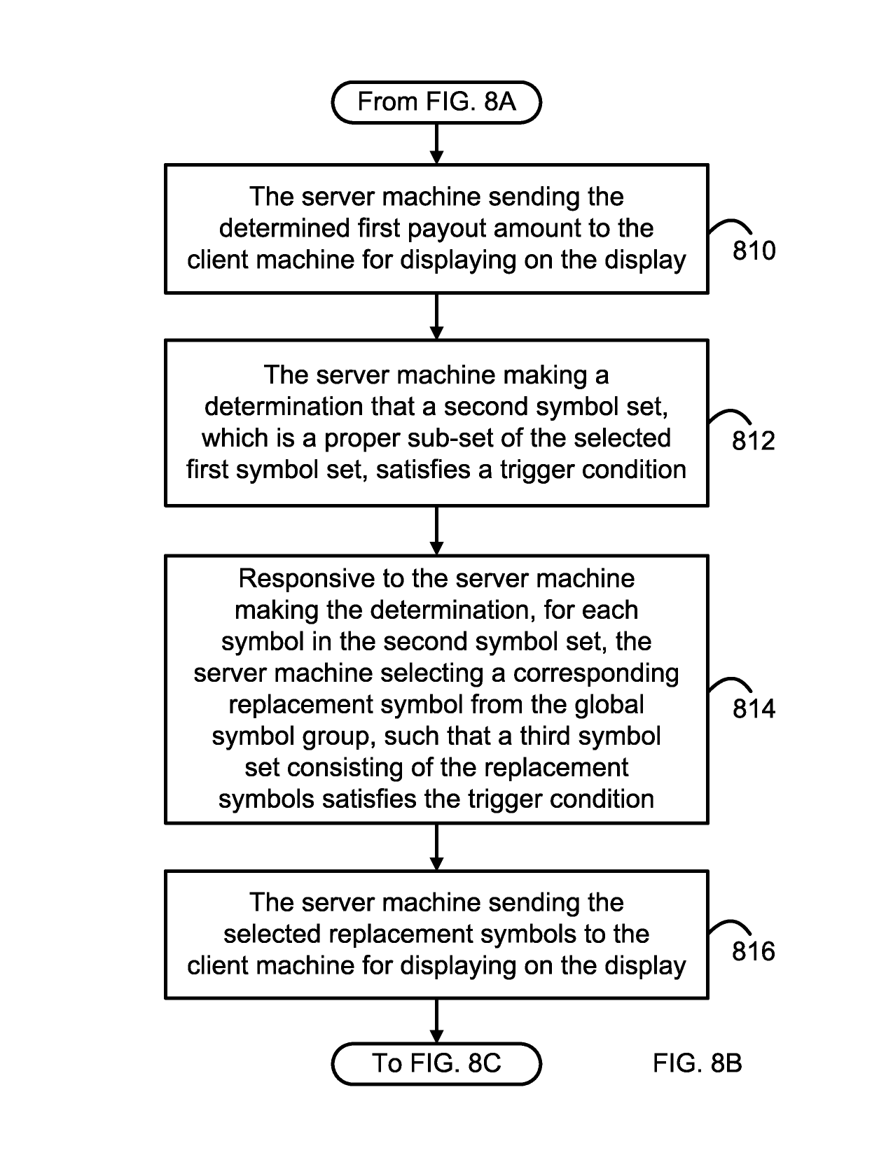

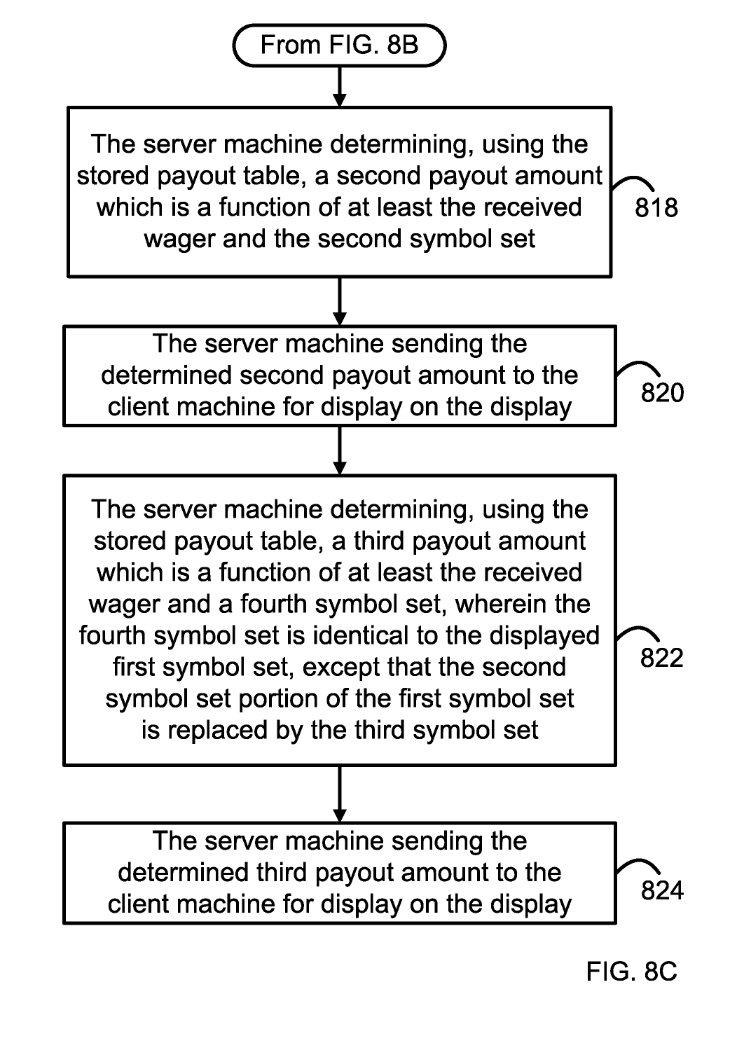

FIGS. 8A-8C show a flow chart showing functions in accordance with an example method in connection with the server machine 100a. Note that several of the functions described in connection with FIGS. 8A-8C parallel functions described in connection with FIGS. 3A-3C. As such, variations of the functions described in connection with FIGS. 3A-3C are likewise applicable to the functions described in connection with FIGS. 8A-8C. However, for the sake of brevity, these variations are not repeated.

At block 800, the method may involve the server machine 100a receiving a wager from the client machine 100b.

At block 802, the method may involve the server machine 100a receiving a play request from the client machine 100b.

At block 804, the method may involve the server machine 100a selecting a first symbol set from a global symbol group.

At block 806, the method may involve the server machine 100a sending the selected first symbol set to the client machine 100b to display on the display 100b. In one example, the server machine 100a may send a displayable image associated with each symbol in the selected first symbol set to the client machine 100b. In another example, the server machine 100a may send an identifier associated with each symbol in the selected first symbol set to the client machine 100b. In one example, the server machine 100a may also send the corresponding arrangement position of each symbol in the selected first symbol set to the client machine 100b. In another example, such arrangement positions may be implied by the order in which the identifiers are sent.

At block 808, the method may involve the server machine 100a determining, using a stored payout table, a first payout amount, where the first payout amount is a function of at least the received wager and the selected first symbol set.

Turning to FIG. 8B, at block 810, the method may involve the server machine 100a sending the determined first payout amount to the client machine 100b for displaying on the display 110b.

At block 812, the method may involve the server machine 100a making a determination that a second symbol set, which is a proper sub set of the selected first symbol set, satisfies a trigger condition.

At block 814, the method may involve responsive to the server machine 100a making the determination, for each symbol in the second symbol set, the server machine 100a selecting a corresponding replacement symbol from the global symbol group, such that a third symbol set consisting of the replacement symbols satisfies the trigger condition (i.e., the same trigger condition satisfied by the second symbol set).

At block 816, the method may involve the server machine 100a sending the selected replacement symbols to the client machine 100b for displaying on the display 100b.

Turning to FIG. 8C, at block 818, the method may involve the server machine 100a determining, using the stored payout table, a second payout amount which is a function of at least the received wager and the second symbol set.

At block 820, the method may involve the server machine 100a sending the determined second payout amount to the client machine 100b for display on the display 110b.

At block 822, the method may involve the server machine 100a determining, using the stored payout table, a third payout amount which may be a function of the received wager, a fourth symbol set, and/or an arrangement of the symbols in the fourth symbol set, wherein the fourth symbol set is identical to the displayed first symbol set, except that the second symbol set portion of the first symbol set is replaced by the third symbol set.

At block 824, the method may involve the server machine 100a sending the determined third payout amount to the client machine 100b for display on the display 110b.

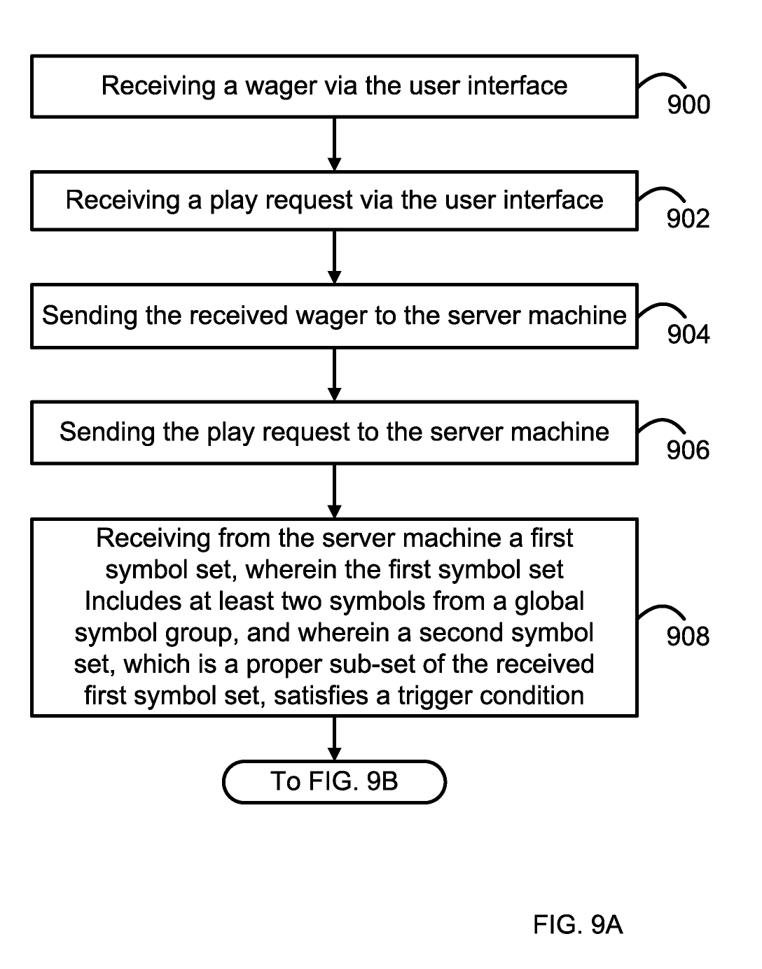

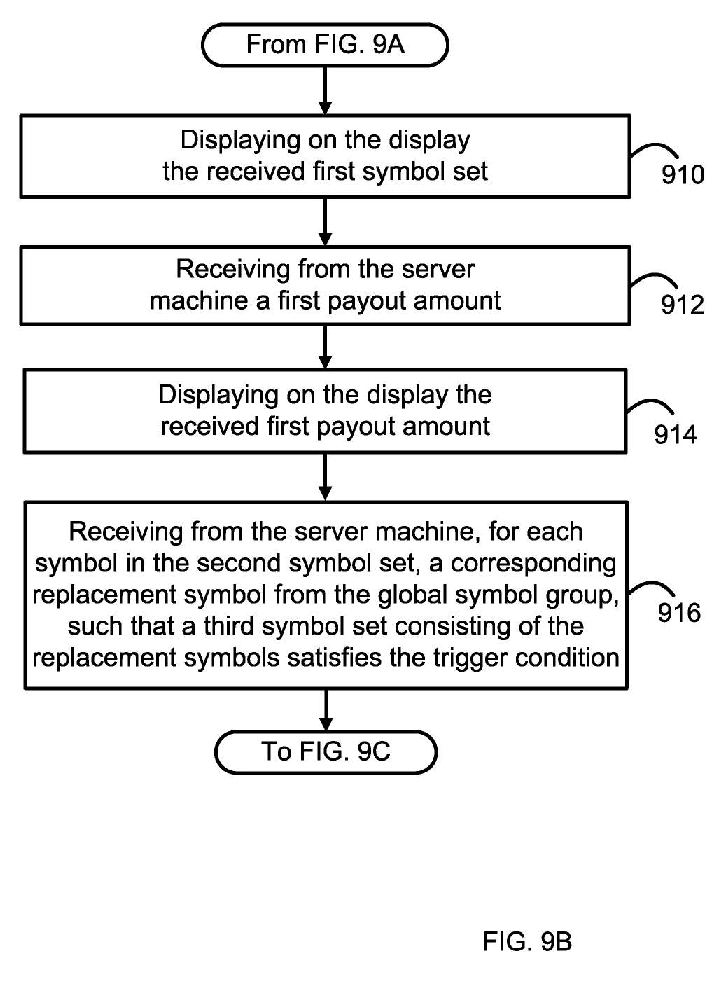

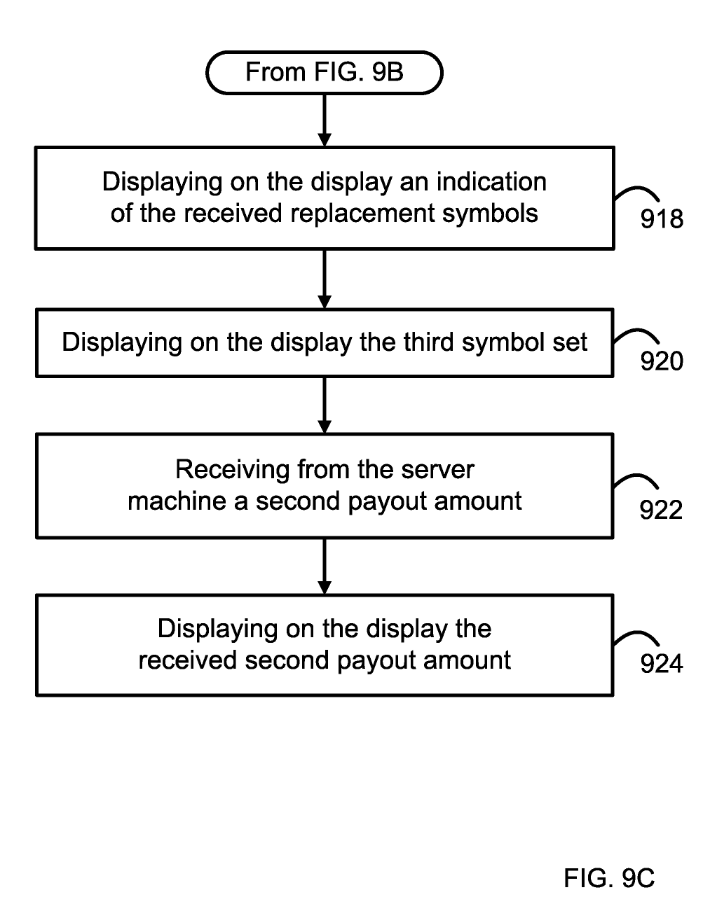

FIGS. 9A-9C show a flow chart showing functions in accordance with an example method in connection with the client machine 100b. Note that several of the functions described in connection with FIGS. 9A-9C parallel functions described in connection with FIGS. 3A-3C and 8A-8C. As such, variations of the functions described in connection with FIGS. 3A-3C and 8A-8C are likewise applicable to the functions described in connection with FIGS. 9A-9C. However, for the sake of brevity, these variations are not repeated.

At block 900, the method may involve the client machine 100b receiving a wager via the user interface 104b.

At block 902, the method may involve the client machine 100b receiving a play request via the user interface 104b.

At block 904, the method may involve the client machine 100b sending the received wager to the server machine 100a.

At block 906, the method may involve the client machine 100b sending the play request to the server machine 100a.

At block 908, the method may involve the client machine 100b receiving from the server machine 100a a first symbol set, where the first symbol set includes at least two symbols from a global symbol group, and wherein a second symbol set, which is a proper sub-set of the received first symbol set, satisfies a trigger condition. In one example, the client machine 100b receives the first symbol set from the server machine 100a in response to the client machine 100b sending the play request to the server machine 100a.

Turning to FIG. 9C, at block 910, the method may involve the client machine 100b displaying on the display 110b the received first symbol set.

At block 912, the method may involve the client machine 100b receiving from the server machine 100a a first payout amount, responsive to sending the received wager to the server machine 100a. In one example, the first payout amount is a function of the received wager and the received first symbol set.

At block 914, the method may involve the client machine 100b displaying on the display 110a the received first payout amount.

At block 916, the method may involve the client machine 100b receiving from the server machine 110a, for each symbol in the second symbol set, a corresponding replacement symbol from the global symbol group, such that a third symbol set consisting of the replacement symbols satisfies the trigger condition (i.e., the same trigger condition satisfied by the second symbol set).

Turning to FIG. 9C, at block 918, the method may involve the client machine 100b displaying on the display 110b an indication of the received replacement symbols.

At block 920, the method may involve the client machine 100b displaying on the display 110b the third symbol set.

At block 922, the method may involve the client machine 100b receiving from the server machine 100a a second payout amount. In one example, the second payout amount may be a function of the received wager, the third symbol set and/or an arrangement of the symbols in the third symbol set.

At block 924, the method may involve the client machine 100b displaying on the display 110b the received second payout amount.

The following examples set out further or alternative aspects of the disclosure. The references to items in Figures or to Figures are for ease of reference only and are not limiting on the scope of the disclosures in accordance with these various aspects.

1. A machine (100) comprising: a display (110) configured to display symbols in a game; a processor (112); and a non-transitory computer readable medium storing program instructions, that when executed by the processor (112), cause a set of functions to be performed, the set of functions comprising:

selecting a first symbol set (500) from a global symbol group, wherein the first symbol set (500) includes at least two symbols (502);

displaying on the display (110) the selected first symbol set (500);

making a determination that a second symbol set (504), which is a proper sub-set of the selected first symbol set (500), satisfies a trigger condition;

responsive to making the determination, for each symbol in the second symbol set (504), selecting a corresponding replacement symbol from the global symbol group, such that a third symbol set (600) consisting of the replacement symbols satisfies the trigger condition; and

displaying on the display (110) the third symbol set (600). (FIGS. 1, 3A-3C, and 4-6).

2. The machine (100) recited in example 1, the set of functions further comprising:

receiving a play request via a user interface (104), wherein selecting the first symbol set (500) from the global symbol group occurs in response to receiving the play request. (FIGS. 1, 3A-3C, and 4-6).

3. The machine (100) recited in example 1 or 2, wherein each symbol in the global symbol group corresponds with a respective number from a set of numbers, and wherein selecting the first symbol set (500) from the global symbol group comprises using a random number generator to select numbers from the set of numbers to select symbols corresponding with the selected numbers. (FIGS. 1, 3A-3C, and 4-6).

4. The machine (100) recited in one of examples 1-3, wherein each symbol (502) in the selected first symbol set (500) corresponds with a respective arrangement position in a column and row arrangement, and wherein displaying the selected first symbol set (500) comprises displaying each symbol from the selected first symbol set (500) according to the corresponding arrangement position. (FIGS. 1, 3A-3C, and 4-6).

5. The machine (100) recited in example 4, wherein the selected first symbol set (500) includes twenty symbols (502), and wherein the column and row arrangement comprises five columns and four rows. (FIGS. 1, 3A-3C, and 4-6)

6. The machine (100) recited in one of examples 1-5, wherein the selected first symbol set (500) includes multiple sub-sets, wherein the global symbol group includes multiple sub-groups, wherein each sub-set corresponds to a respective one of the sub-groups, and wherein selecting the first symbol set (500) from the global symbol group comprises selecting each sub-set from the corresponding sub-group. (FIGS. 1, 3A-3C, and 4-6)

7. The machine (100) recited in one of examples 1-5, wherein each symbol in the selected first symbol set (500) corresponds with a respective arrangement position in a column and row arrangement, wherein the selected first symbol set (500) includes multiple sub-sets, wherein each sub-set corresponds to a respective column in the column and row arrangement, wherein displaying on the display (110) the selected first symbol set (500) comprises displaying each sub-set in the corresponding column. (FIGS. 1, 3A-3C, and 4-6)

8. The machine (100) recited in example 7, wherein displaying on the display (110) the selected first symbol set (500) comprises superimposing each sub-set over a corresponding virtual reel. (FIGS. 1, 3A-3C, and 4-6).

9. The machine (100) recited in one of examples 1-8, wherein each symbol (502) in the selected first symbol set (500) corresponds with a respective displayable image, and wherein displaying on the display (110) the selected first symbol set (500) comprises for each symbol of the selected first symbol set (500), displaying a corresponding displayable image. (FIGS. 1, 3A-3C, and 4-6).

10. The machine (100) recited in one of examples 1-9, wherein the trigger condition comprises a condition of including a particular combination of symbols. (FIGS. 1, 3A-3C, and 4-6).

11. The machine (100) recited in one of examples 1-3 or 6-10, wherein each symbol in the selected first symbol set (500) corresponds with a respective arrangement position in a column and row arrangement, and wherein the trigger condition comprises a condition of including a particular combination of symbols that correspond with particular respective positions in the column and row arrangement. (FIGS. 1, 3A-3C, and 4-6).

12. The machine (100) recited in example 11, wherein the trigger condition comprises a condition of including a combination of five of the same symbols that correspond with five respective arrangement positions that collectively constitute a single row of the column and row arrangement. (FIGS. 1, 3A-3C, and 4-6).

13. The machine (100) recited in one of examples 1-12, wherein the second symbol set (504) includes at least two symbols. (FIGS. 1, 3A-3C, and 4-6).

14. The machine (100) recited in example 13, wherein the symbols in the second symbol set (504) are the same. (FIGS. 1, 3A-3C, and 4-6).

15. The machine (100) recited in one of examples 1-14, the set of functions further comprising:

displaying on the display (110) an indication of the or each symbol in the second symbol set (504). (FIGS. 1, 3A-3C, and 4-6).

16. The machine (100) recited in example 15, wherein displaying on the display (110) the indication of the or each symbol in the second symbol set (504) comprises highlighting the or each symbol in the second symbol set (504). (FIGS. 1, 3A-3C, and 4-6).

17. The machine (100) recited in one of examples 1-16, wherein each symbol in the third symbol set (600) is the same symbol. (FIGS. 1, 3A-3C, and 4-6).

18. The machine (100) recited in one of examples 1-17, the set of functions further comprising:

displaying on the display (110) a virtual spinning reel that is superimposed over at least one of the symbols in the second symbol set (504). (FIGS. 1, 3A-3C, and 4-6).

19. The machine (100) recited in one of examples 1-18, the set of functions further comprising:

making a determination that the third symbol set (504) satisfies the trigger condition. (FIGS. 1, 3A-3C, and 4-6).

20. The machine (100) recited in example 19, the set of functions further comprising:

responsive to making the determination that the third symbol set (504) satisfies the trigger condition, displaying on the display (110) an indication that the trigger condition has twice been satisfied. (FIGS. 1, 3A-3C, and 4-7).

21. The machine (100) recited in one of examples 1-20, wherein a payout table is stored in the computer readable medium, the set of functions further comprising:

receiving a wager via a user interface;

determining, using the stored payout table, a first payout amount, wherein the first payout amount is a function of at least the received wager and the selected first symbol set (500); and

determining, using the stored payout table, a second payout amount. (FIGS. 1, 3A-3C, and 4-6).

22. The machine (100) recited in example 21, wherein the second payout amount is a function of at least the received wager and the third symbol set (600). (FIGS. 1, 3A-3C, and 4-6).

23. The machine (100) recited in example 21, wherein the second payout amount is a function of the received wager and the selected first symbol set (500). (FIGS. 1, 3A-3C, and 4-6).

24. The machine (100) recited in one of examples 21-23, the set of functions further comprising:

displaying the determined first payout amount. (FIGS. 1, 3A-3C, and 4-6).

25. The machine (100) recited in one of examples 21-23, the set of functions further comprising:

displaying the determined second payout amount. (FIGS. 1, 3A-3C, and 4-6).

26. The machine (100) recited in one of examples 21-25, the set of functions further comprising:

displaying a combined total of the determined first payout amount and the determined second payout amount. (FIGS. 1, 3A-3C, and 4-6).

27. The machine (100) recited in one of examples 1-26, wherein the display (110) is configured to display symbols in a wager game. (FIGS. 1, 3A-3C, and 4-6).

28. A method comprising:

a gaming machine (100) selecting a first symbol set (500) from a global symbol group, wherein the first symbol set (500) includes at least two symbols (502);

the machine (100) displaying on a display (110) the selected first symbol set (500);

the machine (100) making a determination that a second symbol set (504), which is a proper sub-set of the selected first symbol set (500), satisfies a trigger condition;

responsive to the machine (100) making the determination, for each symbol in the second symbol set (504), the machine (100) selecting a corresponding replacement symbol from the global symbol group, such that a third symbol set (600) consisting of the replacement symbols satisfies the trigger condition; and

the machine (100) displaying on the display (110) the third symbol set (600). (FIGS. 1, 3A-3C, and 4-6).

29. The method (100) recited in example 28, further comprising:

receiving a play request via a user interface (104), wherein selecting the first symbol set (500) from the global symbol group occurs in response to receiving the play request. (FIGS. 1, 3A-3C, and 4-6).

30. The method (100) recited in example 28 or 29, wherein each symbol in the global symbol group corresponds with a respective number from a set of numbers, and wherein selecting the first symbol set (500) from the global symbol group comprises using a random number generator to select numbers from the set of numbers to select symbols corresponding with the selected numbers. (FIGS. 1, 3A-3C, and 4-6).

31. The method (100) recited in one of examples 28-30, wherein each symbol (502) in the selected first symbol set (500) corresponds with a respective arrangement position in a column and row arrangement, and wherein displaying the selected first symbol set (500) comprises displaying each symbol from the selected first symbol set (500) according to the corresponding arrangement position. (FIGS. 1, 3A-3C, and 4-6).

32. The method (100) recited in example 31, wherein the selected first symbol set (500) includes twenty symbols (502), and wherein the column and row arrangement comprises five columns and four rows. (FIGS. 1, 3A-3C, and 4-6)

33. The method (100) recited in one of examples 28-32, wherein the selected first symbol set (500) includes multiple sub-sets, wherein the global symbol group includes multiple sub-groups, wherein each sub-set corresponds to a respective one of the sub-groups, and wherein selecting the first symbol set (500) from the global symbol group comprises selecting each sub-set from the corresponding sub-group. (FIGS. 1, 3A-3C, and 4-6)

34. The method (100) recited in one of examples 28-32, wherein each symbol in the selected first symbol set (500) corresponds with a respective arrangement position in a column and row arrangement, wherein the selected first symbol set (500) includes multiple sub-sets, wherein each sub-set corresponds to a respective column in the column and row arrangement, wherein displaying on the display (110) the selected first symbol set (500) comprises displaying each sub-set in the corresponding column. (FIGS. 1, 3A-3C, and 4-6)

35. The method (100) recited in example 34, wherein displaying on the display (110) the selected first symbol set (500) comprises superimposing each sub-set over a corresponding virtual reel. (FIGS. 1, 3A-3C, and 4-6).

36. The method (100) recited in one of examples 28-35, wherein each symbol (502) in the selected first symbol set (500) corresponds with a respective displayable image, and wherein displaying on the display (110) the selected first symbol set (500) comprises for each symbol of the selected first symbol set (500), displaying a corresponding displayable image. (FIGS. 1, 3A-3C, and 4-6).

37. The method (100) recited in one of examples 28-36, wherein the trigger condition comprises a condition of including a particular combination of symbols. (FIGS. 1, 3A-3C, and 4-6).

38. The method (100) recited in one of examples 28-30 or 33-37, wherein each symbol in the selected first symbol set (500) corresponds with a respective arrangement position in a column and row arrangement, and wherein the trigger condition comprises a condition of including a particular combination of symbols that correspond with particular respective positions in the column and row arrangement. (FIGS. 1, 3A-3C, and 4-6).

39. The method (100) recited in example 38, wherein the trigger condition comprises a condition of including a combination of five of the same symbols that correspond with five respective arrangement positions that collectively constitute a single row of the column and row arrangement. (FIGS. 1, 3A-3C, and 4-6).

40. The method (100) recited in one of examples 28-39, wherein the second symbol set (504) includes at least two symbols. (FIGS. 1, 3A-3C, and 4-6).

41. The method (100) recited in example 40, wherein the symbols in the second symbol set (504) are the same. (FIGS. 1, 3A-3C, and 4-6).

42. The method (100) recited in one of examples 28-41, further comprising:

displaying on the display (110) an indication of the or each symbol in the second symbol set (504). (FIGS. 1, 3A-3C, and 4-6).

43. The method (100) recited in example 42, wherein displaying on the display (110) the indication of the or each symbol in the second symbol set (504) comprises highlighting the or each symbol in the second symbol set (504). (FIGS. 1, 3A-3C, and 4-6).

44. The method (100) recited in one of examples 28-43, wherein each symbol in the third symbol set (600) is the same symbol. (FIGS. 1, 3A-3C, and 4-6).

45. The method (100) recited in one of examples 27-44, further comprising:

displaying on the display (110) a virtual spinning reel that is superimposed over at least one of the symbols in the second symbol set (504). (FIGS. 1, 3A-3C, and 4-6).

46. The method (100) recited in one of examples 28-45, further comprising:

making a determination that the third symbol set (504) satisfies the trigger condition. (FIGS. 1, 3A-3C, and 4-6).

47. The method (100) recited in example 46, further comprising:

responsive to making the determination that the third symbol set (504) satisfies the trigger condition, displaying on the display (110) an indication that the trigger condition has twice been satisfied. (FIGS. 1, 3A-3C, and 4-7).

48. The method (100) recited in one of examples 28-47, wherein a payout table is stored in the computer readable medium, further comprising:

receiving a wager via a user interface;

determining, using the stored payout table, a first payout amount, wherein the first payout amount is a function of at least the received wager and the selected first symbol set (500); and

determining, using the stored payout table, a second payout amount. (FIGS. 1, 3A-3C, and 4-6).

49. The method (100) recited in example 48, wherein the second payout amount is a function of at least the received wager and the third symbol set (600). (FIGS. 1, 3A-3C, and 4-6).

50. The method (100) recited in example 48, wherein the second payout amount is a function of the received wager and the selected first symbol set (500). (FIGS. 1, 3A-3C, and 4-6).

51. The method (100) recited in one of examples 48-50, further comprising:

displaying the determined first payout amount. (FIGS. 1, 3A-3C, and 4-6).

52. The method (100) recited in one of examples 48-50, further comprising:

displaying the determined second payout amount. (FIGS. 1, 3A-3C, and 4-6).

53. The method (100) recited in one of examples 48-52, further comprising:

displaying a combined total of the determined first payout amount and the determined second payout amount. (FIGS. 1, 3A-3C, and 4-6).

54. The method (100) recited in one of examples 28-53, wherein the display (110) is configured to display symbols in a wager game. (FIGS. 1, 3A-3C, and 4-6).

55. A server machine (100a) comprising: a processor (112a) and a non-transitory computer readable medium storing program instructions, that when executed by the processor (112a), cause a set of functions to be performed, the set of functions comprising:

selecting a first symbol set from a global symbol group, wherein the first symbol set (500) includes at least two symbols (502);

sending the selected first symbol set to a client machine (100b) for display on a display (110b);

making a determination that a second symbol set (504), which is a proper sub set of the selected first symbol set (500), satisfies a trigger condition;

responsive to making the determination, for each symbol in the second symbol set (504), selecting a corresponding replacement symbol from the global symbol group, such that a third symbol set (600) consisting of the replacement symbols satisfies the trigger condition; and

sending the selected replacement symbols to the client machine (100b) for displaying on the display (110b). (FIGS. 2, 8A-8C, and 4-6).

56. The server machine (100a) recited in example 55, the set of functions further comprising:

receiving a play request from the client machine (100b), wherein selecting the first symbol set (500) from the global symbol group occurs in response to receiving the play request. (FIGS. 2, 8A-8C, and 4-6).

57. The server machine (100a) recited in example 55 or 56, wherein each symbol in the global symbol group corresponds with a respective number from a set of numbers, and wherein selecting the first symbol set (500) from the global symbol group comprises using a random number generator to select numbers from the set of numbers to select symbols corresponding with the selected numbers. (FIGS. 2, 8A-8C, and 4-6).

58. The server machine (100a) recited in one of examples 55-57, wherein each symbol (502) in the selected first symbol set (500) corresponds with a respective arrangement position in a column and row arrangement. (FIGS. 2, 8A-8C, and 4-6).

59. The server machine (100a) recited in example 58, wherein the selected first symbol set (500) includes twenty symbols (502), and wherein the column and row arrangement comprises five columns and four rows. (FIGS. 2, 8A-8C, and 4-6).

60. The server machine (100a) recited in one of examples 55-59, wherein the selected first symbol set (500) includes multiple sub-sets, wherein the global symbol group includes multiple sub-groups, wherein each sub-set corresponds to a respective one of the sub-groups, and wherein selecting the first symbol set (500) from the global symbol group comprises selecting each sub-set from the corresponding sub-group. (FIGS. 2, 8A-8C, and 4-6).

61. The server machine (100a) recited in one of examples 55-57 and 59, wherein each symbol in the selected first symbol set (500) corresponds with a respective arrangement position in a column and row arrangement, wherein the selected first symbol set (500) includes multiple sub-sets, wherein each sub-set corresponds to a respective column in the column and row arrangement. (FIGS. 2, 8A-8C, and 4-6).

62. The server machine (100a) recited in one of examples 55-61, wherein each symbol (502) in the selected first symbol set (500) corresponds with a respective displayable image. (FIGS. 2, 8A-8C, and 4-6).

63. The server machine (100a) recited in one of examples 55-62, wherein the trigger condition comprises a condition of including a particular combination of symbols. (FIGS. 2, 8A-8C, and 4-6).

64. The server machine (100a) recited in one of examples 55-57 or 60-63, wherein each symbol in the selected first symbol set (500) corresponds with a respective arrangement position in a column and row arrangement, and wherein the trigger condition comprises a condition of including a particular combination of symbols that correspond with particular respective positions in the column and row arrangement. (FIGS. 2, 8A-8C, and 4-6).

65. The server machine (100a) recited in example 64, wherein the trigger condition comprises a condition of including a combination of five of the same symbols that correspond with five respective arrangement positions that collectively constitute a single row of the column and row arrangement. (FIGS. 2, 8A-8C, and 4-6).

66. The server machine (100a) recited in one of examples 55-65, wherein the second symbol set (504) includes at least two symbols. (FIGS. 2, 8A-8C, and 4-6).

67. The server machine (100a) recited in example 66, wherein each symbol in the second symbol set (504) is the same symbol. (FIGS. 2, 8A-8C, and 4-6).

68. The server machine (100a) recited in one of examples 55-67, wherein each symbol in the third symbol set (600) is the same symbol. (FIGS. 2, 8A-8C, and 4-6).

69. The server machine (100a) recited in one of examples 55-68, the set of functions further comprising:

making a determination that the third symbol set (504) satisfies the trigger condition. (FIGS. 2, 8A-8C, and 4-6).

70. The server machine (100a) recited in one of examples 55-69, wherein a payout table is stored in the computer readable medium, the set of functions further comprising:

receiving a wager from the client machine (100b);

determining, using the stored payout table, a first payout amount, wherein the first payout amount is a function of at least the received wager and the selected first symbol set (500); and

determining, using the stored payout table, a second payout amount. (FIGS. 2, 8A-8C, and 4-6).

71. The server machine (100a) recited in example 70, wherein the second payout amount is a function of at least the received wager and the third symbol set (600). (FIGS. 2, 8A-8C, and 4-6).

72. The server machine (100a) recited in example 70, wherein the second payout amount is a function of at least the received wager and the selected first symbol set (500). (FIGS. 2, 8A-8C, and 4-6).

73. A method comprising:

selecting a first symbol set from a global symbol group, wherein the first symbol set (500) includes at least two symbols (502);

sending the selected first symbol set to a client machine (100b) for display on a display (110b);

making a determination that a second symbol set (504), which is a proper sub set of the selected first symbol set (500), satisfies a trigger condition;

responsive to making the determination, for each symbol in the second symbol set (504), selecting a corresponding replacement symbol from the global symbol group, such that a third symbol set (600) consisting of the replacement symbols satisfies the trigger condition; and

sending the selected replacement symbols to the client machine (100b) for displaying on the display (110b). (FIGS. 2, 8A-8C, and 4-6).

74. The method recited in example 73, further comprising:

receiving a play request from the client machine (100b), wherein selecting the first symbol set (500) from the global symbol group occurs in response to receiving the play request. (FIGS. 2, 8A-8C, and 4-6).

75. The method recited in example 73 or 74, wherein each symbol in the global symbol group corresponds with a respective number from a set of numbers, and wherein selecting the first symbol set (500) from the global symbol group comprises using a random number generator to select numbers from the set of numbers to select symbols corresponding with the selected numbers. (FIGS. 2, 8A-8C, and 4-6).

76. The method recited in one of examples 73-75, wherein each symbol (502) in the selected first symbol set (500) corresponds with a respective arrangement position in a column and row arrangement. (FIGS. 2, 8A-8C, and 4-6).

77. The method recited in example 76, wherein the selected first symbol set (500) includes twenty symbols (502), and wherein the column and row arrangement comprises five columns and four rows. (FIGS. 2, 8A-8C, and 4-6).

78. The method recited in one of examples 73-77, wherein the selected first symbol set (500) includes multiple sub-sets, wherein the global symbol group includes multiple sub-groups, wherein each sub-set corresponds to a respective one of the sub-groups, and wherein selecting the first symbol set (500) from the global symbol group comprises selecting each sub-set from the corresponding sub-group. (FIGS. 2, 8A-8C, and 4-6).

79. The method recited in one of examples 73-75, wherein each symbol in the selected first symbol set (500) corresponds with a respective arrangement position in a column and row arrangement, wherein the selected first symbol set (500) includes multiple sub-sets, wherein each sub-set corresponds to a respective column in the column and row arrangement. (FIGS. 2, 8A-8C, and 4-6).

80. The method recited in one of examples 73-79, wherein each symbol (502) in the selected first symbol set (500) corresponds with a respective displayable image. (FIGS. 2, 8A-8C, and 4-6).

81. The method recited in one of examples 73-80, wherein the trigger condition comprises a condition of including a particular combination of symbols. (FIGS. 2, 8A-8C, and 4-6).

82. The method recited in one of examples 73-75 or 78-81, wherein each symbol in the selected first symbol set (500) corresponds with a respective arrangement position in a column and row arrangement, and wherein the trigger condition comprises a condition of including a particular combination of symbols that correspond with particular respective positions in the column and row arrangement. (FIGS. 2, 8A-8C, and 4-6).

83. The method recited in example 82, wherein the trigger condition comprises a condition of including a combination of five of the same symbols that correspond with five respective arrangement positions that collectively constitute a single row of the column and row arrangement. (FIGS. 2, 8A-8C, and 4-6).

84. The method recited in one of examples 73-83, wherein the second symbol set (504) includes at least two symbols. (FIGS. 2, 8A-8C, and 4-6).

85. The method recited in example 84, wherein each symbol in the second symbol set (504) is the same symbol. (FIGS. 2, 8A-8C, and 4-6).

86. The method recited in one of examples 73-85, wherein each symbol in the third symbol set (600) is the same symbol. (FIGS. 2, 8A-8C, and 4-6).

87. The method recited in one of examples 73-86, further comprising:

making a determination that the third symbol set (504) satisfies the trigger condition. (FIGS. 2, 8A-8C, and 4-6).

88. The method recited in one of examples 73-87, wherein a payout table is stored in the computer readable medium, the method further comprising:

receiving a wager from the client machine (100b);

determining, using the stored payout table, a first payout amount, wherein the first payout amount is a function of at least the received wager and the selected first symbol set (500); and

determining, using the stored payout table, a second payout amount. (FIGS. 2, 8A-8C, and 4-6).

89. The method recited in example 88, wherein the second payout amount is a function of at least the received wager and the third symbol set (600). (FIGS. 2, 8A-8C, and 4-6).

90. The method recited in example 88, wherein the second payout amount is a function of at least the received wager and the selected first symbol set (500). (FIGS. 2, 8A-8C, and 4-6).

91. A client machine (100b) comprising: a display (110b) configured to display symbols in a game; a processor (112b); and a non-transitory computer readable medium storing program instructions, that when executed by the processor (112b), cause a set of functions to be performed, the set of functions comprising:

receiving from a server machine (100a) a first symbol set (500), wherein the first symbol set (500) includes at least two symbols (502) from a global symbol group, and wherein a second symbol set (504), which is a proper sub-set of the received first symbol set (500), satisfies a trigger condition;

displaying on the display (110b) the received first symbol set (500);

receiving from the server machine (110a), for each symbol in the second symbol set, a corresponding replacement symbol from the global symbol group, such that a third symbol set consisting of the replacement symbols satisfies the trigger condition; and

displaying the third symbol set. (FIGS. 2, 9A-9C, and 4-6).

92. The client machine (100b) recited in example 91, wherein each symbol (502) in the received first symbol set (500) corresponds with a respective arrangement position in a column and row arrangement, and wherein displaying the received first symbol set (500) comprises displaying each symbol from the received first symbol set (500) according to the corresponding arrangement position. (FIGS. 2, 9A-9C, and 4-6).

93. The client machine (100b) recited in example 92, wherein the received first symbol set (500) includes twenty symbols (502), and wherein the column and row arrangement comprises five columns and four rows. (FIGS. 2, 9A-9C, and 4-6).

94. The client machine (100b) recited in one of examples 91-93, wherein the received first symbol set (500) includes multiple sub-sets, wherein the global symbol group includes multiple sub-groups, wherein each sub-set corresponds to a respective one of the sub-groups. (FIGS. 2, 9A-9C, and 4-6).

95. The client machine (100b) recited in example 91, wherein each symbol in the received first symbol set (500) corresponds with a respective arrangement position in a column and row arrangement, wherein the received first symbol set (500) includes multiple sub-sets, wherein each sub-set corresponds to a respective column in the column and row arrangement, wherein displaying on the display (110b) the received first symbol set (500) comprises displaying each sub-set in the corresponding column. (FIGS. 2, 9A-9C, and 4-6).

96. The client machine (100b) recited in example 95, wherein displaying on the display (110b) the received first symbol set (500) comprises superimposing each sub-set over a corresponding virtual reel. (FIGS. 2, 9A-9C, and 4-6).

97. The client machine (100b) recited in one of examples 91-96, wherein each symbol (502) in the received first symbol set (500) corresponds with a respective displayable image, and wherein displaying on the display (110b) the received first symbol set (500) comprises for each symbol of the received first symbol set (500), displaying a corresponding displayable image. (FIGS. 2, 9A-9C, and 4-6).

98. The client machine (100b) recited in one of examples 91-97, wherein the trigger condition comprises a condition of including a particular combination of symbols. (FIGS. 2, 9A-9C, and 4-6).

99. The client machine (100b) recited in one of examples 91 or 94-97, wherein each symbol in the received first symbol set (500) corresponds with a respective arrangement position in a column and row arrangement, and wherein the trigger condition comprises a condition of including a particular combination of symbols that correspond with particular respective positions in the column and row arrangement. (FIGS. 2, 9A-9C, and 4-6).

100. The client machine (100b) recited in example 99, wherein the trigger condition comprises a condition of including a combination of five of the same symbols that correspond with five respective arrangement positions that collectively constitute a single row of the column and row arrangement. (FIGS. 2, 9A-9C, and 4-6).

101. The client machine (100b) recited in one of examples 91-100, wherein the second symbol set (504) includes at least two symbols. (FIGS. 2, 9A-9C, and 4-6).

102. The client machine (100b) recited in example 101, wherein each symbol in the second symbol set (504) is the same symbol. (FIGS. 2, 9A-9C, and 4-6).

103. The client machine (100b) recited in one of examples 91-102, the set of functions further comprising:

displaying on the display (110b) an indication of the or each symbol in the second symbol set (504). (FIGS. 2, 9A-9C, and 4-6).

104. The client machine (100b) recited in example 103, wherein displaying on the display (110b) the indication of the or each symbol in the second symbol set (504) comprises highlighting the or each symbol in the second symbol set (504). (FIGS. 2, 9A-9C, and 4-6).

105. The client machine (100b) recited in one of examples 91-104, wherein each symbol in the third symbol set (600) is the same symbol. (FIGS. 2, 9A-9C, and 4-6).

106. The client machine (100b) recited in one of examples 91-105, the set of functions further comprising:

displaying on the display (110b) a virtual spinning reel that is superimposed over at least one of the symbols in the second symbol set (504). (FIGS. 2, 9A-9C, and 4-6).

107. A method comprising:

receiving from a server machine (100a) a first symbol set (500), wherein the first symbol set (500) includes at least two symbols (502) from a global symbol group, and wherein a second symbol set (504), which is a proper sub-set of the received first symbol set (500), satisfies a trigger condition;

displaying on the display (110b) the received first symbol set (500);

receiving from the server machine (110a), for each symbol in the second symbol set, a corresponding replacement symbol from the global symbol group, such that a third symbol set consisting of the replacement symbols satisfies the trigger condition; and

displaying the third symbol set. (FIGS. 2, 9A-9C, and 4-6).

108. The method recited in example 107, wherein each symbol (502) in the received first symbol set (500) corresponds with a respective arrangement position in a column and row arrangement, and wherein displaying the received first symbol set (500) comprises displaying each symbol from the received first symbol set (500) according to the corresponding arrangement position. (FIGS. 2, 9A-9C, and 4-6).

109. The method recited in example 108, wherein the received first symbol set (500) includes twenty symbols (502), and wherein the column and row arrangement comprises five columns and four rows. (FIGS. 2, 9A-9C, and 4-6).

110. The method recited in one of examples 107-109, wherein the received first symbol set (500) includes multiple sub-sets, wherein the global symbol group includes multiple sub-groups, wherein each sub-set corresponds to a respective one of the sub-groups. (FIGS. 2, 9A-9C, and 4-6).

111. The method recited in example 107, wherein each symbol in the received first symbol set (500) corresponds with a respective arrangement position in a column and row arrangement, wherein the received first symbol set (500) includes multiple sub-sets, wherein each sub-set corresponds to a respective column in the column and row arrangement, wherein displaying on the display (110b) the received first symbol set (500) comprises displaying each sub-set in the corresponding column. (FIGS. 2, 9A-9C, and 4-6).

112. The method recited in example 111, wherein displaying on the display (110b) the received first symbol set (500) comprises superimposing each sub-set over a corresponding virtual reel. (FIGS. 2, 9A-9C, and 4-6).

113. The method recited in one of examples 107-112, wherein each symbol (502) in the received first symbol set (500) corresponds with a respective displayable image, and wherein displaying on the display (110b) the received first symbol set (500) comprises for each symbol of the received first symbol set (500), displaying a corresponding displayable image. (FIGS. 2, 9A-9C, and 4-6).

114. The method recited in one of examples 107-113, wherein the trigger condition comprises a condition of including a particular combination of symbols. (FIGS. 2, 9A-9C, and 4-6).

115. The method recited in one of examples 107 or 110-114, wherein each symbol in the received first symbol set (500) corresponds with a respective arrangement position in a column and row arrangement, and wherein the trigger condition comprises a condition of including a particular combination of symbols that correspond with particular respective positions in the column and row arrangement. (FIGS. 2, 9A-9C, and 4-6).

116. The method recited in example 115, wherein the trigger condition comprises a condition of including a combination of five of the same symbols that correspond with five respective arrangement positions that collectively constitute a single row of the column and row arrangement. (FIGS. 2, 9A-9C, and 4-6).

117. The method recited in one of examples 107-116, wherein the second symbol set (504) includes at least two symbols. (FIGS. 2, 9A-9C, and 4-6).

118. The method recited in example 117, wherein each symbol in the second symbol set (504) is the same symbol. (FIGS. 1, 3A-3C, and 4-6).

119. The method recited in one of examples 107-118, further comprising:

displaying on the display (110b) an indication of the or each symbol in the second symbol set (504). (FIGS. 2, 9A-9C, and 4-6).

120. The method recited in example 119, wherein displaying on the display (110b) the indication of the or each symbol in the second symbol set (504) comprises highlighting the or each symbol in the second symbol set (504). (FIGS. 2, 9A-9C, and 4-6).

121. The method recited in one of examples 107-120, wherein each symbol in the third symbol set (600) is the same symbol. (FIGS. 2, 9A-9C, and 4-6).

122. The method recited in one of examples 107-121, further comprising:

displaying on the display (110b) a virtual spinning reel that is superimposed over at least one of the symbols in the second symbol set (504). (FIGS. 2, 9A-9C, and 4-6).

While one or more functions of the presently disclosed method have been described as being performed by the certain entities (e.g., the machine 100, the server machine 100a, or the client machine 100b), one or more of the functions may be performed by any entity, including but not limited to those described herein. As such, while this disclosure includes examples in which the server machine 100a performs select functions and sends data to the client machine 100b, such that the client machine 100b may perform complementing functions and receive the data, variations may to those functions may be made while adhering to the general server client dichotomy and the scope of the disclosed machines and methods.

For example, rather than the server machine 100a sending select data (e.g., a symbol set) to the client machine 100b, such that the client machine may generate and display appropriate images, the server machine 100a may itself generate the images and send them to the client machine 100b for display. Indeed, it will be appreciated by one of ordinary skill in the art that the “break point” between the server machine's functions and the client machine's functions may be varied with ease.

Further, the described functions throughout this application need not be performed in the disclosed order, although in some examples, the recited order may be preferred. Also, not all functions need to be performed to achieve the desired advantages of disclosed machines and methods, and therefore not all functions are required.

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

1. A machine comprising: a display configured to display symbols in a game; a processor; and a non-transitory computer readable medium storing program instructions, that when executed by the processor, cause a set of functions to be performed, the set of functions comprising:
selecting a first symbol set from a global symbol group, wherein the first symbol set includes at least two symbols;
displaying on the display the selected first symbol set;
making a determination that a second symbol set, which is a proper sub-set of the selected first symbol set, satisfies a trigger condition;
responsive to making the determination, for each symbol in the second symbol set, selecting a corresponding replacement symbol from the global symbol group, such that a third symbol set consisting of the replacement symbols satisfies the trigger condition; and
displaying on the display the third symbol set.

2. The machine recited in claim 1, wherein each symbol in the global symbol group corresponds with a respective number from a set of numbers, and wherein selecting the first symbol set from the global symbol group comprises using a random number generator to select numbers from the set of numbers to select symbols corresponding with the selected numbers.

3. The machine recited in claim 1, wherein each symbol in the selected first symbol set corresponds with a respective arrangement position in a column and row arrangement, wherein the selected first symbol set includes multiple sub-sets, wherein each sub-set corresponds to a respective column in the column and row arrangement, and wherein displaying on the display the selected first symbol set comprises displaying each sub-set in the corresponding column.

4. The machine recited in claim 3, wherein displaying on the display the selected first symbol set comprises superimposing each sub-set over a corresponding virtual reel.

5. The machine recited in claim 1, wherein the trigger condition comprises a condition of including a particular combination of symbols.

6. The machine recited in claim 1, wherein each symbol in the selected first symbol set corresponds with a respective arrangement position in a column and row arrangement, and wherein the trigger condition comprises a condition of including a particular combination of symbols that correspond with particular respective positions in the column and row arrangement.

7. The machine recited in claim 1, the set of functions further comprising:
displaying on the display an indication of the or each symbol in the second symbol set.

8. The machine recited in claim 1, the set of functions further comprising:
displaying on the display a virtual spinning reel that is superimposed over at least one of the symbols in the second symbol set.

9. The machine recited in claim 1, wherein a payout table is stored in the computer readable medium, the set of functions further comprising:
receiving a wager via a user interface;
determining, using the stored payout table, a first payout amount, wherein the first payout amount is a function of at least the received wager and the selected first symbol set;
determining, using the stored payout table, a second payout amount; and
displaying a combined total of the determined first payout amount and the determined second payout amount.

10. A method comprising:
a gaming machine selecting a first symbol set from a global symbol group, wherein the first symbol set includes at least two symbols;
the machine displaying on a display the selected first symbol set;
the machine making a determination that a second symbol set, which is a proper sub-set of the selected first symbol set, satisfies a trigger condition;
responsive to the machine making the determination, for each symbol in the second symbol set, the machine selecting a corresponding replacement symbol from the global symbol group, such that a third symbol set consisting of the replacement symbols satisfies the trigger condition; and
the machine displaying on the display the third symbol set.

11. The method recited in claim 10, wherein each symbol in the global symbol group corresponds with a respective number from a set of numbers, and wherein selecting the first symbol set from the global symbol group comprises using a random number generator to select numbers from the set of numbers to select symbols corresponding with the selected numbers.

12. The method recited in claim 10, wherein each symbol in the selected first symbol set corresponds with a respective arrangement position in a column and row arrangement, wherein the selected first symbol set includes multiple sub-sets, wherein each sub-set corresponds to a respective column in the column and row arrangement, and wherein displaying on the display the selected first symbol set comprises displaying each sub-set in the corresponding column.

13. The method recited in claim 12, wherein displaying on the display the selected first symbol set comprises superimposing each sub-set over a corresponding virtual reel.

14. The method recited in claim 10, wherein the trigger condition comprises a condition of including a particular combination of symbols.

15. The method recited in claim 10, wherein each symbol in the selected first symbol set corresponds with a respective arrangement position in a column and row arrangement, and wherein the trigger condition comprises a condition of including a particular combination of symbols that correspond with particular respective positions in the column and row arrangement.

16. The method recited in claim 10, further comprising:
displaying on the display an indication of the or each symbol in the second symbol set.

17. The method recited in claim 10, further comprising:
displaying on the display a virtual spinning reel that is superimposed over at least one of the symbols in the second symbol set.

18. The method recited in claim 10, wherein a payout table is stored in a computer readable medium, further comprising:
receiving a wager via a user interface;
determining, using the stored payout table, a first payout amount, wherein the first payout amount is a function of at least the received wager and the selected first symbol set;
determining, using the stored payout table, a second payout amount; and
displaying a combined total of the determined first payout amount and the determined second payout amount.

19. A server machine comprising: a processor and a non-transitory computer readable medium storing program instructions, that when executed by the processor, cause a set of functions to be performed, the set of functions comprising:
selecting a first symbol set from a global symbol group, wherein the first symbol set includes at least two symbols;
sending the selected first symbol set to a client machine for display on a display;
making a determination that a second symbol set, which is a proper sub set of the selected first symbol set, satisfies a trigger condition;
responsive to making the determination, for each symbol in the second symbol set, selecting a corresponding replacement symbol from the global symbol group, such that a third symbol set consisting of the replacement symbols satisfies the trigger condition; and
sending the selected replacement symbols to the client machine for displaying on the display.

20. A client machine comprising: a display configured to display symbols in a game; a processor; and a non-transitory computer readable medium storing program instructions, that when executed by the processor, cause a set of functions to be performed, the set of functions comprising:
receiving from a server machine a first symbol set, wherein the first symbol set includes at least two symbols from a global symbol group, and wherein a second symbol set, which is a proper sub-set of the received first symbol set, satisfies a trigger condition;
displaying on the display the received first symbol set;
receiving from the server machine, for each symbol in the second symbol set, a corresponding replacement symbol from the global symbol group, such that a third symbol set consisting of the replacement symbols satisfies the trigger condition; and
displaying the third symbol set.
